(19) United States
(12) Patent Application Publication
(10) Pub. No.: US 2026/0094197 A1
(43) Pub. Date: Apr. 2, 2026

(54) ARTIFICIAL INTELLIGENCE (AI)-BASED ENGAGEMENT MODEL FOR EVENT MANAGEMENT SYSTEM

(71) Applicant: Live Nation Entertainment, Inc., Beverly Hills, CA (US)

(72) Inventors: Ashish Ravindra Gupta, Los Angeles, CA (US); Madison Erin Hays, Nashville, TN (US)

(73) Assignee: Live Nation Entertainment, Inc., Beverly Hills, CA (US)

(21) Appl. No.: 19/343,933

(22) Filed: Sep. 29, 2025

Related U.S. Application Data
(60) Provisional application No. 63/700,341, filed on Sep. 27, 2024.

(51) Int. Cl. G06Q 30/0601

(52) U.S. Cl. CPC G06Q 30/0631

(57) ABSTRACT

Systems and methods for providing a set of recommendations associated with an event based on contextual relationship between user attributes and attainability vectors using an artificial intelligence (AI) engagement agent. The method comprises receiving a natural language-based user query for the set of recommendations on a first interface. The method further comprises identifying the user attributes from the natural language-based user query. The method further comprises determining a plurality of attainability vectors from a vector database based on the user attributes. The method further comprises identifying the contextual relationship between the user attributes and the plurality of attainability vectors. The method further comprises identifying, using the AI engagement agent, the set of recommendations based on the contextual relationship between the user attributes and the plurality of attainability vectors. The method further comprises displaying the set of recommendations on a second interface.

### PRIORITY

This application is a non-provisional of and claims priority to U.S. Provisional Patent Application No. 63/700,341 , filed Sep. 27, 2024, the contents of which is incorporated herein by reference in its entirety.

### BACKGROUND

This disclosure relates, in general, to providing recommendations for the events and venues for users.

Currently, multiple search engines, chatbots, and mobile applications provide a list of recommended events and venues to users based on the search string entered by the user. However, this traditional approach of keyword-based search engines provides several irrelevant results that do not consider specific user preferences, and filtering relevant results using the keywords becomes a time consuming and cumbersome task. Furthermore, critical requirements of the users, like parking preference, food, lighting, ambiance, seating, noise, music, or indoor/outdoor venues, cannot be explicitly captured in the results.

The users probably expect a list of events from the search engines and chatbots that are closest to their requirements and preferences. For example, a list of events that pertain to the user's interests is presented to the user. Providing relevant results increases conversion of site visits and browsing activities to sales.

### SUMMARY

In one embodiment, the present disclosure provides one or more techniques that aims to eliminate the drawbacks of the traditional check-in process by introducing a new system to provide recommendation of events to the user based on user specific requirements and user preferences using artificial intelligence techniques.

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Certain embodiments of the present disclosure described herein relate to systems and methods for providing a set of recommendations associated with an event based on contextual relationship between user attributes and attainability vectors using an artificial intelligence (AI) engagement agent. The method comprises receiving a natural language-based user query for the set of recommendations on a first interface. The method further comprises identifying the user attributes from the user query. The method further comprises determining a plurality of attainability vectors from a vector database based on the user attributes. The method further comprises identifying the contextual relationship between the user attributes and the plurality of attainability vectors. The method further comprises identifying using the AI engagement agent, the set of recommendations based on the contextual relationship between the user attributes and the plurality of attainability vectors. The method further comprises displaying the set of recommendations on a second interface. Other embodiments of this aspect include corresponding computer systems, apparatus, and computer programs recorded on one or more computer storage devices, each configured to perform the actions of the methods.

Certain aspects and features of the present disclosure relate to a method of providing a set of recommendations associated with an event of a plurality of events based on contextual relationship between user attributes and a plurality of attainability vectors using an artificial intelligence (AI) engagement agent. The method comprises receiving a natural language-based user query for the set of recommendations on a first interface. The method further comprises identifying the user attributes from the user query. The method further comprises determining the plurality of attainability vectors from a vector database based on the user attributes. The method further comprises identifying the contextual relationship between the user attributes and the plurality of attainability vectors. The method further comprises identifying using the AI engagement agent, the set of recommendations based on the contextual relationship between the user attributes and the plurality of attainability vectors. The method further comprises displaying the set of recommendations on a second interface. The first interface and the second interface are displayed using a system application run on an end-user device. Other embodiments of this aspect include corresponding computer systems, apparatus, and computer programs recorded on one or more computer storage devices, each configured to perform the actions of the methods.

One general aspect includes the method further comprising: determining a plurality of venues for a set of events; filtering the set of events based on venue availability to get a filtered set of events; and providing a set of recommended events on the end-user device based on the filtered set of events. Other embodiments of this aspect include corresponding computer systems, apparatus, and computer programs recorded on one or more computer storage devices, each configured to perform the actions of the methods.

In various embodiments, the user attributes are associated with user prerequisites, wherein the user prerequisites include parking preferences, lighting, ambience, very important person (VIP) seating, food, music, indoor or outdoor venues, and real-time updates from a user. Other embodiments of this aspect include corresponding computer systems, apparatus, and computer programs recorded on one or more computer storage devices, each configured to perform the actions of the methods.

In various embodiments, a chat-based prototype on the first interface uses the AI engagement agent to process the user query; filter a set of events from a plurality of clusters based on user information from the user attributes, the plurality of clusters includes a mapping of venues, categories and subcategories associated with the plurality of events, and the mapping is stored in the vector database; provide a set of recommended events on the end-user device based on the set of events; request a user input to change the user query; receive the user input on the first interface to update the set of recommended events based on a change in the user query; and dynamically present in real-time, an updated set of recommended events on the second interface. Other embodiments of this aspect include corresponding computer systems, apparatus, and computer programs recorded on one or more computer storage devices, each configured to perform the actions of the methods.

In various embodiments, the categories include genre, and the subcategories include sub-genres in music, and the plurality of clusters includes nodes connected with edges, the nodes indicate venue locations and edges indicate user preferences. Other embodiments of this aspect include corresponding computer systems, apparatus, and computer programs recorded on one or more computer storage devices, each configured to perform the actions of the methods.

In various embodiments, the method further comprising: obtaining additional information related to a user, the additional information includes user preferences, user activities, and schedules; filtering the set of events based on the additional information to generate a filtered set of events; and providing a set of recommended events to the user on the second interface based on the filtered set of events. Other embodiments of this aspect include corresponding computer systems, apparatus, and computer programs recorded on one or more computer storage devices, each configured to perform the actions of the methods.

In various embodiments, the method further comprising: obtaining user patterns based on user information from the user attributes, the user patterns include user activities, user location, user preferences, and real-time user schedules; obtaining using the AI engagement agent, the set of events and corresponding set of recommendations from a plurality of clusters based on the user patterns, wherein the plurality of clusters includes a mapping of events, venues, categories and subcategories associated with the plurality of events, and the mapping is stored in the vector database; and generating a set of recommended events on the second interface based on the set of events. Other embodiments of this aspect include corresponding computer systems, apparatus, and computer programs recorded on one or more computer storage devices, each configured to perform the actions of the methods.

In various embodiments, the plurality of attainability vectors is determined based on the user attributes using a plurality of vectors from the vector database, and the plurality of vectors indicates availability of the user attributes of a plurality of users registered in the vector database. Other embodiments of this aspect include corresponding computer systems, apparatus, and computer programs recorded on one or more computer storage devices, each configured to perform the actions of the methods.

Certain aspects and features of the present disclosure relate to an event management system for providing a set of recommendations associated with an event of a plurality of events based on contextual relationship between user attributes and attainability vectors using an artificial intelligence (AI) engagement agent. The event management system comprises a system application running on an end-user device, the system application includes a first interface and a second interface, and the event management system further comprises an AI engagement agent configured to process the user query to provide search results. The AI engagement agent is further configured to receive a natural language-based user query for the set of recommendations on a first interface. The AI engagement agent is further configured to identify the user attributes from the user query. The AI engagement agent is further configured to determine a plurality of attainability vectors from a vector database based on the user attributes. The AI engagement agent is further configured to identify the contextual relationship between the user attributes and the plurality of attainability vectors. The AI engagement agent is further configured to identify the set of recommendations based on the contextual relationship between the user attributes and the plurality of attainability vectors. The AI engagement agent is further configured to display the set of recommendations on the second interface. The first interface and the second interface are displayed using the system application run on the end-user device. Other embodiments of this aspect include corresponding computer systems, apparatus, and computer programs recorded on one or more computer storage devices, each configured to perform the actions of the methods.

Certain aspects and features of the present disclosure relate to a non-transitory computer-readable medium containing instructions that, when executed by a processor, cause the processor to perform a method for providing artificial intelligence (AI) based ticket booking to a plurality of users. A natural language-based user query for the set of recommendations on a first interface is received. The user attributes are identified from the user query. A plurality of attainability vectors is determined from a vector database based on the user attributes. The contextual relationship is identified between the user attributes and the plurality of attainability vectors. The set of recommendations are identified using the AI engagement agent, based on the contextual relationship between the user attributes and the plurality of attainability vectors. The set of recommendations are displayed on a second interface. The first interface and the second interface are displayed using a system application run on an end-user device. Other embodiments of this aspect include corresponding computer systems, apparatus, and computer programs recorded on one or more computer storage devices, each configured to perform the actions of the methods.

### BRIEF DESCRIPTION OF THE DRAWINGS

The present disclosure is described in conjunction with the appended figures:

FIG. 1 illustrates a block diagram of an event management system;

FIG. 2 illustrates a block diagram of a user device and application interface;

FIG. 3 illustrates a block diagram of a venue management device;

FIG. 4 illustrates a block diagram of an end-user device;

FIG. 5 illustrates a block diagram of an Artificial Intelligence (AI) engagement agent;

FIG. 6 illustrates a block diagram of a filter of an Artificial Intelligence (AI) engagement agent;

FIG. 7 illustrates an illustration depicting a set of clusters of a clustering engine of an Artificial Intelligence (AI) engagement agent;

FIG. 8 illustrates an event management interface for event recommendations displayed to a user on a user device in;

FIG. 9 illustrates an event management application designed to provide event recommendations to users;

FIG. 10 illustrates an automated classification process and an AI data classification of an event management interface of an AI engagement agent of an event management system;

FIG. 11 illustrates an event management interface designed to manage and automate event data classification;

FIG. 12 illustrates an event management interface designed to manage and classify event-related information;

FIG. 13 illustrates an event management application designed to provide event recommendations to users;

FIG. 14 illustrates a flowchart describing a process for recommending a set of events based on user preferences using AI techniques;

FIG. 15 illustrates a flowchart of a process for recommending a set of events based on user search entered using a chat-based prototype and an AI engagement agent;

FIG. 16 illustrates a flowchart of a process for recommending a set of events based on clusters of events using an AI engagement agent;

FIG. 17 illustrates a flowchart of a process for recommending a set of events based on additional user information using an AI engagement agent;

FIG. 18 illustrates a flowchart of a process for recommending events based on user patterns using an AI engagement agent;

FIG. 19 illustrates a flowchart of a process for providing a set of recommendations associated with an event based on contextual relationship between user attributes and attainability vectors; and

FIG. 20 illustrates a flowchart of a process for providing the set of recommendations based on user feedback on previous recommendations.

In the appended figures, similar components and/or features may have the same reference label. Where the same reference label is used in the specification, the description applies to any one of the similar components having the same reference label.

### DETAILED DESCRIPTION

The ensuing description provides preferred exemplary embodiment(s) only and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

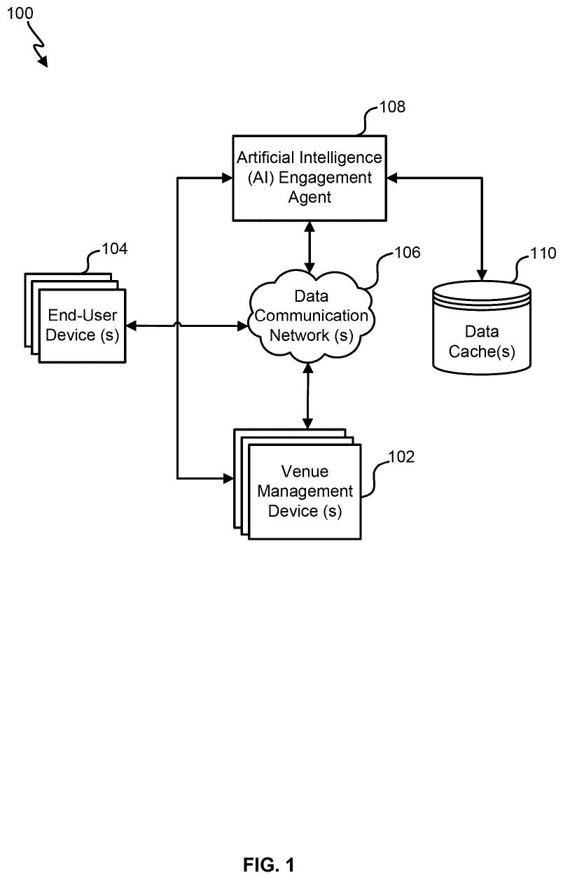

Referring to FIG. 1, illustrates a block diagram of an event management system 100, according to an embodiment of the present disclosure. The event management system 100 includes venue management device(s) 102, end-user device(s) 104, data communication network(s) 106, artificial intelligence (AI) engagement agent 108, and data cache(s) 110. Different components of the event management system 100 are connected via the data communication network(s) 106. The data communication network(s) 106 can provide a wireless connection with other components.

In some configurations, the venue management device(s) 102 can be operated by one or more event providers hosting a live event at a venue. The venue management device(s) 102 can generate and/or transmit event related information and event-provider communication. The venue management device(s) 102 may be provided with the event related information by the venue management device(s) 102 or a third party/external server(s) (not shown). For example, the venue management device(s) 102 can send an event provider communication that indicates Location Y in New York and will host a series of periods (e.g., a series of the play Hamilton on 10 particular nights).

In one embodiment, an individual location associated with a single series of periods is identified from the event provider communication. For example, the received event provider communication indicates an area of Location Y for hosting a single series of Hamilton shows between March 2018 and April 2018.

In another embodiment, the received event provider communication can indicate multiple locations associated with various series of periods. For example, the received event provider communication can indicate Location Y for hosting a series of Hamilton shows between March 2018 and April 2018 and the location Raleigh Arena in Raleigh, N.C., for hosting a series of Hamilton shows between June 2018 and July 2018. As can be seen, a series of periods can correspond to a series of events of a particular performance or show at a particular venue (e.g., location). In such an embodiment, every single performance can occur at a particular location at a particular period.

The event providers use servers (not shown) or the venue management device(s) 102 to transmit tickets to users and receive purchase amounts for the tickets. The user may receive event ticket and venue information from the event provider via the servers (not shown) or the AI engagement agent 108 or the venue management device(s) 102. The user can book tickets directly from the venue management device(s) 102. The AI engagement agent 108 provides the ticket to the user on an end-user device(s) 104 of the user after successful payment for the ticket. The user presents the ticket to a scanner (not shown), which identifies the ticket and presents the ticket to the AI engagement agent 108 for user verification. The AI engagement agent 108 authenticates the ticket provided by the scanner.

In an embodiment, the venue management device(s) 102 may request the server (not shown) or third-party servers (not shown) of the event providers to provide details of the ticket to match it with the details of the ticket provided by the scanner. The event providers may give the ticket details to the venue management device(s) 102 on receiving a request from the venue management device(s) 102. The venue management device(s) 102 matches the details of the ticket with the details provided by the event providers to authenticate the ticket credentials of the ticket user and authorize access to the user for entering the event.

The end-user device(s) 104 can be used to request the assignment of tickets/tokens from the event providers. The end-user device(s) 104 can be any portable computing device, e.g., smartphones, mobile phones, tablets, and/or other similar devices. A single user (or a fan) attending an event inside the venue can carry the end-user device(s) 104 with them inside the venue. A plurality of activities can be performed with the help of the end-user device(s) 104, for example, but not limited, carrying a ticket in digital form for the event, entering inside the venue using the digital ticket present on an application running on the end-user device(s) 104, making purchases inside the venue using the end-user device(s) 104. For example, while presenting a ticket at an event entrance, end-user device(s) 104 may communicate with the scanner over a short-range communication channel, such as Bluetooth or Bluetooth Low Energy channel, Near Field Communication (NFC), Wireless Fidelity (Wi-Fi), Radio Frequency Identification (RFID), Zigbee, Advanced Network Technology (ANT), etc.

The user via the end-user device(s) 104 bearing a ticket, requests entry into an event venue (e.g., a stadium, a fairground, a concert hall, a lecture hall, etc.). The user is entailed to provide the ticket to the scanner(s) for access to the event. A gatekeeper (e.g., a ticket collector or guard located at the venue entrance) checks the ticket and/or an additional form of identification (by way of example, a driver's license, a passport, a state identity card, a national identify card, a credit card, and/or a smart card) to determine if there is a match (e.g., that the ticket user's name on the ticket matches the name on the additional form of identification).

The user enters a search query on a user interface of the end-user device(s) 104 to receive recommendations associated with events and venues in which the user is interested. The end-user device(s) 104 hosts a mobile application, a browser or a website interface on the end-user device(s) 104 to enable the user to enter the search query using the user interface. The mobile application, the browser link, or the website interface operates the event management system 100.

The scanner(s) may include a bar code scanner, a magnetic card reader, and/or a camera that can scan the ticket presented by the user at the gate or entrance of the event venue. The scanner(s) communicate with the venue management device(s) 102 and the AI engagement agent 108 to identify the authenticity of the user. The scanner(s) may include a camera to scan the ticket and provide the data of the ticket to the venue management device(s) 102 for verification. The video is encoded using video steganography.

The AI engagement agent 108 processes a search query entered by the user via the end-user device(s) 104. The AI engagement agent 108 includes one or more machine learning models to process the search query, extract user preferences and user interests to identify a set of recommended events for the user. The AI engagement agent 108 uses the search query to identify the user and retrieves the associated user profile from the data cache(s) 110. The user profile includes user preferences, user attributes, interests, and schedules. The AI engagement agent 108 uses the data cache(s) 110 to retrieve a set of clusters of events. The cluster of events is based on a three-dimensional (3D) model to capture events based on a set of attributes like locations, user preferences, venue locations, or user profiles. The cluster of events includes events aggregated in a cluster based on the set of attributes. The AI engagement agent 108 identifies a cluster relevant to the user profile of the user. The AI engagement agent 108 determines a list of recommendations of events based on the user profile. The list of recommendations of events are presented to the user on the end-user device(s) 104.

For example, the user enters a search string on the user interface of the end-user device(s) 104 displaying the mobile or web application of the event management system 100.

The search string may be “rock music events nearby this weekend”. The AI engagement agent 108 of the event management system 100 processes the search string entered by the user to identify the user and retrieves the user profile of the user from the data cache(s) 110. The data cache(s) 110 store user historical booking data in the user profile, user preferences, user interests, user information, and user attributes like physical appearance and behavior etc. Further, real-time updates of the user, such as the current user location, schedules, especially for weekends, parking preferences, etc., are obtained by continuous monitoring of user's past and present activities and bookings for events. These real-time updates are also stored in the data cache(s) 110 for retrieval by the AI engagement agent 108. The AI engagement agent 108 uses the keywords in the search string to identify rock music concerts and events near the user's current location from the venue management device 102. The AI engagement agent 108 uses the user profile and real-time updates of the user to filter a set of events and provide a refined set of recommendations to the user that is specific to the user's prerequisites.

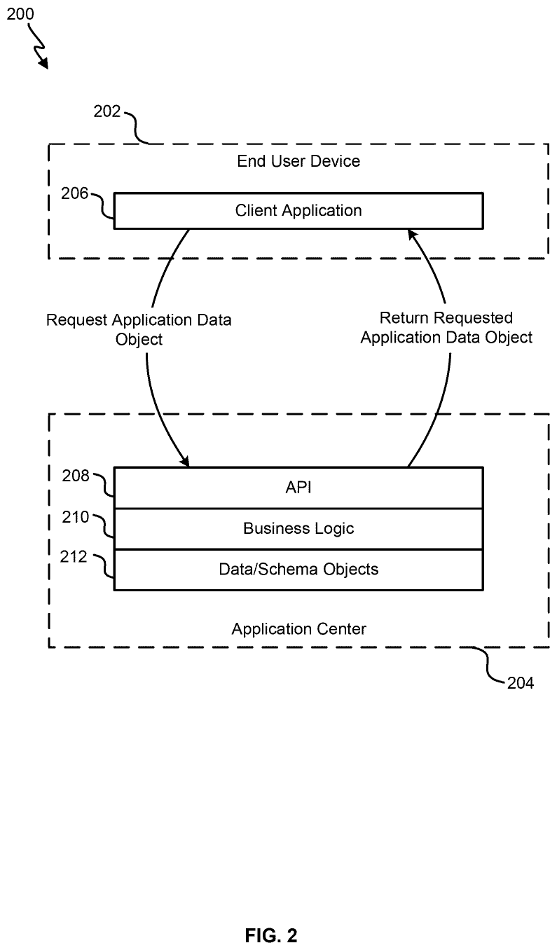

Referring to FIG. 2, illustrates a block diagram 200 of a user device and an application interface embedded with a system and/or apparatus for ticket booking according to an embodiment of the present disclosure. In one embodiment, the block diagram 200 includes an end-user device 202 and an application center 204, which are communicatively coupled. In some embodiments, the end-user device 202 includes a client application 206 such that the client application 206 requests application data objects from the application center 204. Further, the application center 204 includes an application program interface (API) 208, a business logic 210, and data/schema objects 212 for performing various operations on data before transmitting data back to the client application.

In some embodiments, the client application 206 is downloaded from the application center 204 and then installed on the end-user device 202. The client application 206, upon execution on the end-user device 202, provides various features and options for ticket booking.

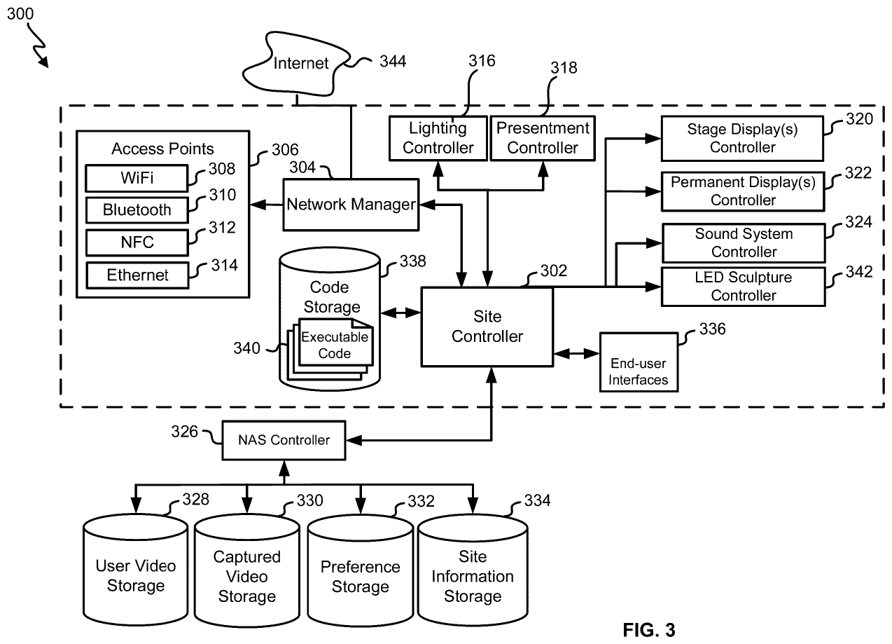

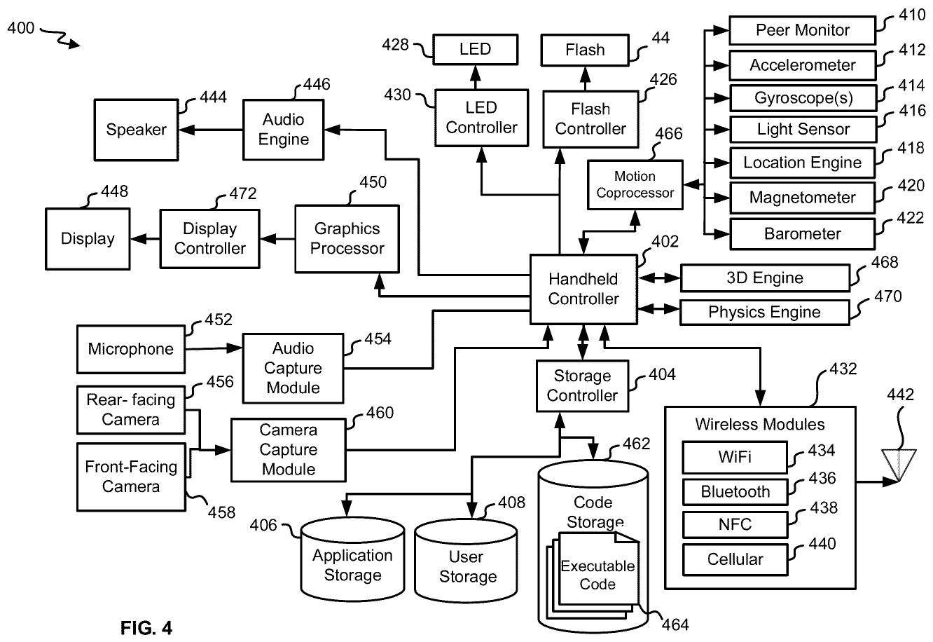

Referring to FIG. 3, illustrates a block diagram of a venue management device 300 according to an embodiment of the present disclosure. Embodiments of a site controller 302 use a network manager 304 to connect via access points 306 (using e.g., a Wi-Fi 308, Bluetooth 310, a Near Field Technology (NFC) 312, an Ethernet 314, and/or other network connections) to other network components, such as site network and the end-user device(s) 104 (not shown herein and described in FIG. 4 as 400). In some embodiments, the site controller 302 controls aspects of an event location. A broad variety of location features can be controlled by different embodiments, including permanent lights (e.g., with a lighting controller 316), stage lights (e.g., with presentment controller 318), stage display screens (e.g., with stage display(s) controller 320), permanent display screens (e.g., with permanent display(s) controller 322), the location sound system (e.g., with a sound system controller 324) and LED sculpture controller 342.

A Network Attached Storage (NAS) controller 326 is coupled to a user video storage 328, a captured video storage 330, a preference storage 332, and a site information storage 334. The captured video storage 330 can receive, store, and provide user videos received from end-user device(s). In some embodiments, the site controller 302 triggers the automatic capture of images, audio, and video from the end-user device(s), such triggering being synchronized to activities in an event. Images captured by this and similar embodiments can be stored on both the capturing end-user device(s) and the user video storage 328. In an embodiment, the site controller 302 can coordinate the transfer of information from the end-user device(s) to the NAS controller 326 (e.g., captured media) with activities taking place during the event. When interacting with the end-user device(s), some embodiments of the site controller 302 can provide end-user interfaces 336 to enable different types of interaction. For example, as a part of engagement activities, the site controller 302 can offer quizzes and other content to the devices. Additionally, for location determinations discussed herein, the site controller 302 can supplement determined estimates with voluntarily provided information using the interface of an end-user interface 336, stored in a storage that is not shown. The venue management device 300 can be connected to an internet 344.

In some embodiments, to guide the performance of different activities, the site controller 302 and/or other components can use executable code tangibly stored in code storage 338 comprising executable code 340. In some embodiments, the site information storage 334 can provide information regarding the site, e.g., events, resource maps, attendee information, geographic location of destinations (e.g., concessions, bathrooms, exits, etc.), as well as 3D models of site features and structure.

In one embodiment, every single ticket related transaction is encrypted to save them from any hacking and also use blockchain technology to make ticket sales temper proof. In other words, every single ticket related transaction is recorded in a distributed ledger, and for every single transaction, the distributed ledger gets updated with standout values.

Referring to FIG. 4, illustrates a block diagram of an end-user device 400 according to an embodiment of the present disclosure. The end-user device 400 includes a handheld controller 402 that can be sized and shaped so as to enable the handheld controller 402 and end-user device 400 to be held in hand. The handheld controller 402 can include one or more end user-device processors that can be configured to perform actions as described herein. In some instances, such actions can include retrieving and implementing a rule, retrieving an access-enabling code, generating a communication (e.g., including an access-enabling code) to be transmitted to another device (e.g., a nearby client-associated device, a remote device, a central server, a server, etc.), processing a received communication (e.g., to act in accordance with instruction in the communication, to generate a presentation based on data in the communication, or to generate a response communication that includes data requested in the received communication) and so on. In one embodiment, to guide the performance of different activities, the end-user device can use executable code tangibly stored in code storage 462 comprising executable code 464.

The handheld controller 402 can communicate with a storage controller 404 to facilitate local storage and/or retrieval of data. It will be appreciated if the handheld controller 402 can further facilitate storage and/or retrieval of data at a remote source via generation of communications including the data (e.g., with a storage instruction) and/or requesting particular data.

The storage controller 404 can be configured to write and/or read data from one or more data stores, such as an application storage 406 and/or a user storage 408. One or more data stores can include, for example, Random Access Memory (RAM), Dynamic Random Access Memory (DRAM), Read-Only Memory (ROM), flash-ROM, cache, storage chips, and/or removable memory. The application storage 406 can include various types of application data for singular of one or more applications loaded (e.g., downloaded, or pre-installed) onto the end-user device. For example, one or more applications can include applications venue, the application running non-custodial wallets, and applications for other venue-related purchases. Further, application data can include, for example, application code, settings, profile data, databases, session data, history, cookies, and/or cache data. The user storage 408 can include, for example, files, documents, images, videos, voice recordings, and/or audio. It would be appreciated if the end-user device 400 could also include other types of storage and/or stored data, such as code, files, and data for an operating system configured for execution on end-user device 400.

The handheld controller 402 can also receive and process (e.g., in accordance with code or instructions generated in correspondence to a particular application) data from one or more sensors and/or detection engines. One or more sensors and/or detection engines can be configured to, for example, detect the presence, intensity, and/or the identity of (for example) another device (e.g., a nearby device or device-detectable over a particular type of networks, such as a Bluetooth, Bluetooth Low-Energy or Near-Field Communication network); an environmental, external stimulus (e.g., temperature, water, light, motion or humidity); an internal stimulus (e.g., temperature); a device performance (e.g., processor or memory usage); and/or a network connection (e.g., to indicate whether a particular type of connection is available, network strength and/or network reliability). The sensors and detection engines include a peer monitor 410, an accelerometer 412, a gyroscope 414, a light sensor 416, a location engine 418, a magnetometer 420, and a barometer 422. Singular sensor and/or detection engine can be configured to collect a measurement or decide, for example, at routine intervals or times and/or upon receiving a corresponding request (e.g., from a processor executing an application code).

The peer monitor 410 can monitor communications, networks, radio signals, short-range signals, etc., which can be received by a receiver of an end-user device 400. Peer monitor 410 can, for example, detect short-range communication from another device and/or use a network multicast or broadcast to request identification of nearby devices. Upon or while detecting another device, the peer monitor 410 can determine an identifier, device type, associated user, network capabilities, operating system, and/or authorization associated with the device. The peer monitor 410 can maintain and update a data structure to store a location, identifier, and/or characteristic of every single of one or more nearby end-user devices 400.

The accelerometer 412 can be configured to detect the proper acceleration of end-user device 400. The acceleration can include multiple components associated with various axes and/or total acceleration. The gyroscope 414 can be configured to detect one or more orientations (e.g., via detection of angular velocity) of end-user device 400. The gyroscope 414 can include, for example, one or more spinning wheels or discs, single-or multi-axis (e.g., three-axis) MicroElectroMechanical System (MEMS)-based gyroscopes.

The light sensor 416 can include, for example, a photosensor, such as a photodiode, active-pixel sensor, LED, photoresistor, or other component configured to detect a presence, intensity, and/or type of light. In some instances, one or more sensors and detection engines can include a motion detector, which can be configured to detect motion. Such motion detection can include processing data from one or more light sensors (e.g., performing a temporal and/or differential analysis).

The location engine 418 can be configured to detect (e.g., estimate) the location of end-user device 400. For example, the location engine 418 can be configured to process signals (e.g., a wireless signal, Global Positioning System (GPS) satellite signal, cell-tower signal, iBeacon, or base-station signal) received at one or more receivers (e.g., a wireless-signal receiver and/or GPS receiver) from a source (e.g., a GPS satellite, cellular tower or base station, or WiFi access point) at a defined or identifiable location. In some instances, the location engine 418 can process signals from multiple sources and can estimate the location of end-user device 400 using a triangulation technique. In some instances, the location engine 418 can process a single signal and estimate its location as being the same as the location of the source of the signal.

The end-user device 400 can include a flash 44 and a flash controller 426. The flash 44 can include a light source, such as (for example), an LED, electronic flash, or high-speed flash. The flash controller 426 can be configured to control when the flash 44 emits light. In some instances, the determination includes identifying an ambient light level (e.g., via data received from the light sensor 416) and determining that the flash 44 is to emit light in response to a picture-or movie-initiating input when the light level is below a defined threshold (e.g. when a setting is in an auto-flash mode). In some additional or alternative instances, the determination includes determining that the flash controller 426 is, or is not, to emit light in accordance with a flash on/offsetting. When it is determined that the flash controller 426 is to emit light, the flash controller 426 can be configured to control the timing of the light to coincide, for example, with a time (or right before) at which a picture or video is taken.

The end-user device 400 can also include an LED 428 and an LED controller 430. The LED controller 430 can be configured to control when the LED 428 emits light. The light emission can be indicative of an event, such as whether a message has been received, a request has been processed, an initial access time has passed, etc.

The flash controller 426 can control an operational timing of the flash 44 by controlling a circuit switch. The flash controller 426 controls the circuit switch to complete a circuit between a power source and the flash 44 when the flash 44 is to emit light. In some instances, the flash controller 426 is wired to a shutter mechanism to synchronize light emission and image or video data collection.

The end-user device 400 can be configured to transmit and/or receive signals from other devices or systems (e.g., over one or more networks, such as network(s). These signals can include wireless signals, and accordingly, the end-user device 400 can include one or more wireless modules 432 configured to appropriately facilitate the transmission or receipt of wireless signals of a particular type. The wireless modules 432 can include a Wi-Fi module 434, a Bluetooth module 436, a near-field communication (NFC) module shown as NFC 438, and/or a cellular module 440. Every single module can, for example, generate a signal (e.g., which can include transforming a signal generated by another component of the end-user device 400 to conform to a particular protocol and/or to process a signal (e.g., which can include transforming a signal received from another device to conform with a protocol used by another component of end-user device 400).

The Wi-Fi module 434 can be configured to generate and/or process radio signals with a frequency between 2.4 gigahertz and 5 gigahertz. The Wi-Fi module 434 can include a wireless network interface card that includes circuitry to communicate using a particular standard (e.g., physical and/or link-layer standard). The Bluetooth module 436 can be configured to generate and/or process radio signals with a frequency between 2.4 gigahertz and 2.485 gigahertz. In some instances, Bluetooth module 436 can be configured to generate and/or process Bluetooth low-energy (BLE or BTLE) signals with a frequency between 2.4 gigahertz and 2.485 gigahertz. The NFC 438 can be configured to generate and/or process radio signals with a frequency of 13.56 megahertz. The NFC 438 can include an inductor and/or can interact with one or more loop antennas. The cellular module 440 can be configured to generate and/or process cellular signals at ultra-high frequencies (e.g., between 698 and 2690 megahertz). For example, the cellular module 440 can be configured to generate uplink signals and/or to process received downlink signals.

The signals generated by the wireless modules 432 can be transmitted to one or more other devices (or broadcast) by one or more antennas 442. The signals processed by the wireless module 432 can include those received by one or more antennas 442. The one or more antennas 442 can include, for example, a monopole antenna, helical antenna, antenna, Planar Inverted-F Antenna (PIFA), modified PIFA, and/or one or more loop antennae.

The end-user device 400 can include various input and output components. An output component can be configured to present output. For example, speaker 444 can be configured to present an audio output by converting an electrical signal into an audio signal. An audio engine 446 can affect particular audio characteristics, such as volume, event-to-audio-signal mapping, and/or whether an audio signal is to be avoided due to a silencing mode (e.g., a vibrate or do-not-disturb mode set at the device).

Further, a display 448 is provided with a display controller 472 and can be configured to present a visual output by converting an electrical signal into a light signal. The display 448 can include multiple pixels, every single of which can be individually controllable, such that the intensity and/or color of every single pixel can be independently controlled. The display 448 can include, for example, an LED- or LCD-based display.

A graphics processor 450 can determine a mapping of electronic image data to pixel variables on a screen of the end-user device 400. It can further adjust lighting, texture, and color characteristics in accordance with, for example, user settings.

In some instances, display 448 is a touchscreen display (e.g., a resistive or capacitive touchscreen) and is, thus, both an input and an output component. The graphics processor 450 can be configured to detect whether, where and/or how (e.g., a force of) the user touched display 448. The determination can be made based on capacitive or resistive data analysis.

An input component can be configured to receive input from a user that can be translated into data. For example, end-user device 400 can include a microphone 452 that can capture sound and transform the audio signals into electrical signals. An audio capture module 454 can determine, for example, when an audio signal is to be collected and/or any filter, equalization, noise gate, compression, and/or clipper to be applied to the signal.

The end-user device 400 can further include a rear-facing camera 456, and a front-facing camera 458 every single of which can be configured to capture visual data (e.g., at a given time or across an extended period) and convert the visual data into electrical data (e.g., electronic image or video data). In some instances, end-user device 400 includes multiple cameras, at least two of which are directed in different and/or substantially opposite directions. For example, end-user device 400 can include a rear-facing camera 456 and a front-facing camera 458.

A camera capture module 460 can control, for example, when a visual stimulus is to be collected (e.g., by controlling a shutter), a duration for which a visual stimulus is to be collected (e.g., a time that a shutter is to remain open for a picture taking, which can depend on a setting or ambient light levels; and/or a time that a shutter is to remain open for a video taking, which can depend on inputs), a zoom, a focus setting, and so on. When end-user device 400 includes multiple cameras, the camera capture module 460 can further determine which camera(s) is to collect image data (e.g., based on a setting). In some embodiments, components are included that assist with the processing and utilization of sensor data. Motion coprocessor 466, 3D engine 468, and physics engine 470 can process sensor data and also perform tasks of graphics rendering related to the graphics processor 450.

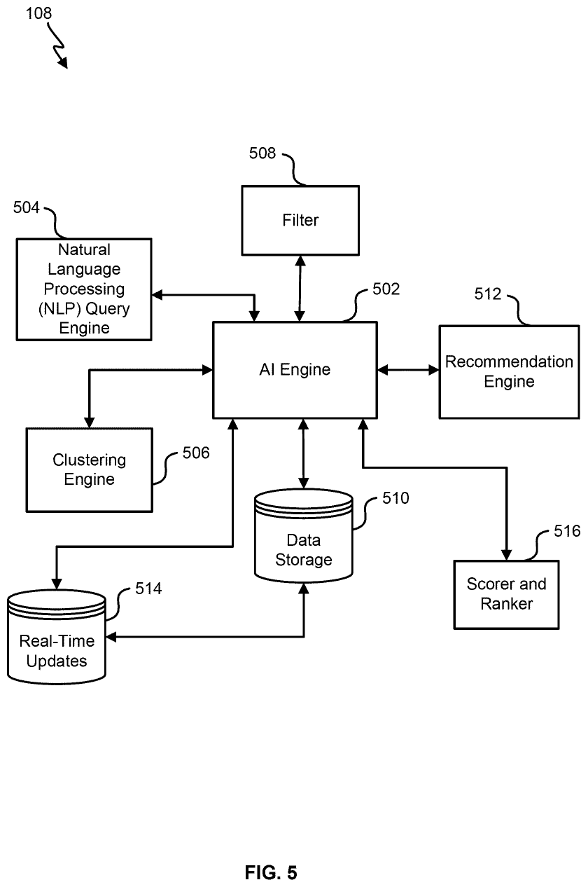

Referring to FIG. 5, illustrates a block diagram of the AI engagement agent 108 according to an embodiment of the present disclosure. The AI engagement agent 108 processes the input query from the user for events, identifies user preferences and determines a list of recommended events to the user based on the user preferences using artificial intelligence techniques. The AI engagement agent 108 includes an AI engine 502, a natural language processing (NLP) query engine 504, a clustering engine 506, a filter 508, data storage 510, a recommendation engine 512, real-time updates 514, and a scorer and ranker 516.

The NLP query engine 504 receives a search query from the user using the first interface of the end-user device(s) 104. The search query includes one or more key strings including single or multiple keywords. The search query may also be in a natural language. The NLP query engine 504 parses the search query to identify the keywords and the search strategy of the user. The NLP query engine 504 provides the identified keywords to the AI engine 502 for retrieval of events and venues from the data storage 510.

The AI engine 502 identifies the user of the search query and receives the search keywords from the NLP query engine 504. The AI engine 502 retrieves real-time updates such as current location and schedules of the user from the real-time updates 514. The AI engine 502 further retrieves user profile of the user from the data storage 510 and provides to the clustering engine 506. The data storage 510 stores the user profile of users. The user profile includes past and current usage history of the event management system 100, user information, booking data of events, browsing or search history of users and user preferences and interests. Real-time updates 514 exchanges real-time location, schedules, bookings, or meetings of the users to the data storage 510. The data storage 510 stores the updated information from the real-time updates 514.

The AI engine 502 identifies one or more clusters of events from the clustering engine 506. The clustering engine 506 generates multiple clusters of events based on the search keywords and the user profile of the user received from the AI engine 502. The clusters of events include events categorized based on the locations, user preferences such as parking, food, ambiance, merchandise, lighting and/or music. The clusters include nodes interconnected by edges. The nodes indicate events and venues, and the edges indicate user preferences. One or more clusters of events are identified by the clustering engine 506 based on the search keywords and the user profile. The one or more clusters are identified and provided by the clustering engine 506 to the AI engine 502.

The AI engine 502 provides the one or more clusters of events to the filter 508 for selecting a set of events from the one or more clusters of events. The filter 508 identifies and provides a set of recommendations for users based on user preferences like seating, lightning, parking, ambience, seat row etc. The filter 508 uses specific prerequisites and preferences of the user to identify the set of events and the set of recommendations from the clusters. The specific prerequisites may be related to very important person (VIP) seating, parking availability, premium parking, valet parking, indoor seating, or outdoor seating with shade. The specific user preferences may be related to food choices like vegetarian, vegan, or non-vegetarian, Italian, continental, Thai, or Mexican, lighting, music like rock, classical, or somber, ambiance, noise levels, day event or night party, etc. The specific prerequisites and preferences of the user are obtained by gathering additional information from the user by questioning the user for the specific prerequisites and preferences. The NLP query engine 504 is instructed by the AI engine 502 to present questions or suggestions to the user on the user interface of the end-user device 104 to acquire the additional information from the user. The user answers the questions and provides supplementary information to assist the NLP query engine 504 in extracting the additional information from the answers.

The additional information is provided to the filter 508 to identify the set of events based on the specific prerequisites and preferences of the user. The set of events is provided to the recommendation engine 512 to analyze the set of events and generate recommendations for the set of events. The recommendation engine 512 adds additional information associated with the events, venues, and user preferences to every single event. For example, details regarding a music concert will include additional information like types of music, artists, genres, sub-genres, ratings, past events, popularity, etc. Further, parking availability, food menu, shopping facilities, very VIP (VVIP) seating arrangement, etc. are added to the respective event. The recommendation engine 512 provides the recommended events to the scorer and ranker 516.

The scorer and ranker 516 uses machine learning techniques to generate scores for every single of the recommended events obtained from the recommendation engine 512. The scorer and ranker 516 generate scores for every single event based on the specific prerequisites and preferences of the user and the additional information provided by the recommendation engine 512 for every single event. Based on the scores of every single event, the events are ranked in the order of scores. A list of recommended events is generated by the scorer and ranker 516 based on the scores and ranked in the increasing order of the scores. The list of recommended events is provided to the AI engine 502 by the scorer and ranker 516. The list of recommended events is presented to the user by the AI engine 502 on the end-user device(s) 104. The list of recommended events and the user specific recommendations based on the user prerequisites are displayed to the user on a second interface of the system application in synchronization with the first interface. The user interacts on the first interface with the AI chatbot of the system application to specify the user prerequisites.

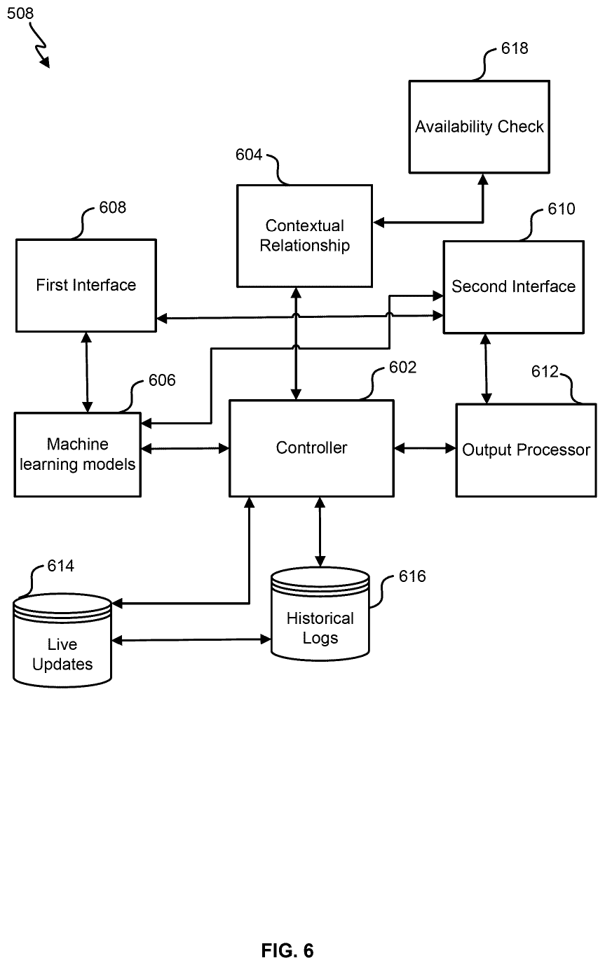

Referring to FIG. 6, illustrates a block diagram of the filter 508 of the Artificial Intelligence (AI) engagement agent 108 according to an embodiment of the present disclosure. The filter 508 provides one or more clusters of events for selecting a set of events from the one or more clusters of events. The filter 508 identifies and provides a set of recommendations for seating, parking, user's budget, and other preferences. The filter 508 includes a controller 602, contextual relationship 604, machine learning models 606, a first interface 608, a second interface 610, an output processor 612, live updates 614, historical logs 616, and an availability check 618.

The controller 602 manages the display of information on the first interface 608 and the second interface 610. The first interface 608 includes a chat-based prototype or an AI chatbot to directly input user query and user preferences. The second interface 610 displays the recommended events, venues, seating, parking, and other user preferences. The first interface 608 and the second interface 610 can be displayed on a single user interface side by side. In another embodiment, the first interface 608 and the second interface 610 can be displayed using swipe left and right on the user interface. The user interface may include multiple interfaces that is more than the first interface 608 and the second interface 610. The first interface 608 and the second interface 610 are switched instantly and updated based on the user query and the recommendations, respectively.

The controller 602 identifies the user attributes from the user query. The user query is provided using the first interface 608 either as voice input, speech input, or text on the AI chatbot. The user attributes are processed using the machine learning models 606 for identifying user prerequisites and user preferences. The machine learning models 606 parse the natural language-based user query to process the user attributes. The machine learning models 606 are trained on user specific prerequisites of every single user interacting with the system application. The system application can include a mobile or web application of the event management system 100 run on the end-user device(s) 104. The live updates 614 provide real-time schedules, user activities, browsing, app activities, shopping preferences, travel or day out schedules, purchase capacity, and social media updates of the users.

The historical logs 616 include historical user activities, browsing logs, app logs other activities, shopping, and travel logs, including expenses of the user. The live updates 614 and historical logs 616 are used by the machine learning models 606 to process the user attributes and suggest recommendations for events and user preferences. The machine learning models 606 process the user attributes to determine user specific prerequisites and provides the user specific prerequisites to the availability check 618 to determine the availability of the user prerequisites. The user specific prerequisites include seating preferences, ambience, location, music, food, budget-friendly seats, etc.

The availability check 618 determines whether the user specific prerequisites are available in the events the user is interested in. The availability check 618 provides a set of vectors indicating the availability of the user specific prerequisites to the controller 602. The availability check 618 determines a plurality of vectors indicating availability of user attributes for every single user. The availability of seating preferences, ambience, location, music, food, budget-friendly seats for every single user who enrolled in the event management system 100 or visited the system application for the first time. The plurality of vectors is stored in a vector database of the data cache(s) 110. The plurality of vectors form clusters associated with events meeting the user specific prerequisites.

The controller 602 determines a plurality of attainability vectors based on the user attributes using the plurality of vectors from the vector database of the data cache(s) 110. The attainability vectors indicate the availability of the user specific prerequisites by checking the prerequisites against an event management server (not shown). The vector database is synchronized with the recent update from the event management server. The attainability vectors include availability of the user specific prerequisites of the user interacting on the first interface 608. The attainability vectors form clusters of events or venues based on meeting the user specific prerequisites.

The contextual relationship 604 identifies the contextual relationship between the user attributes and the plurality of attainability vectors. The contextual relationship 604 provides the contextual relationship between the user attributes and the plurality of attainability vectors to the controller 602. The controller 602 determines a set of recommendations of events along with user specific prerequisites based on the contextual relationship to the output processor 612.

The output processor 612 displays the set of recommendations to the user on the end-user device(s) 104 via the second interface 610. The set of recommendations includes a list of events in an order to meet the utmost number of user prerequisites. For example, the list of events in an order includes five events with event ranked on top of the list meet seven out of ten user prerequisites, like seats, budget, lightning, ambience, food, shopping, parking, artists, music, and venue location. The second event in the list meets six out of ten user prerequisites, the third event in the list meets five out of ten user prerequisites, fourth event in the list meets four out of ten user prerequisites, and fifth event in the list meets three out of ten user prerequisites. In case two or more events meet same number of user prerequisites like two events meet five prerequisites, then the events are ordered in the order of priority of the user prerequisites. For example, for the user, venue location has a priority over budget or parking.

The user reviews the set of recommendations on the second interface 610 and provides feedback on the first interface 608 indicating the user is satisfied with the recommendations and wants to proceed with the booking of the tickets or whether the user wants some changes in the set of recommendations. The feedback may be a change in the user query if the user is not satisfied with the set of recommendations. The updated user query is used to dynamically present in real-time, an updated set of recommended events on the second interface 610. The set of recommended events is updated until the user is satisfied with the set of recommended events.

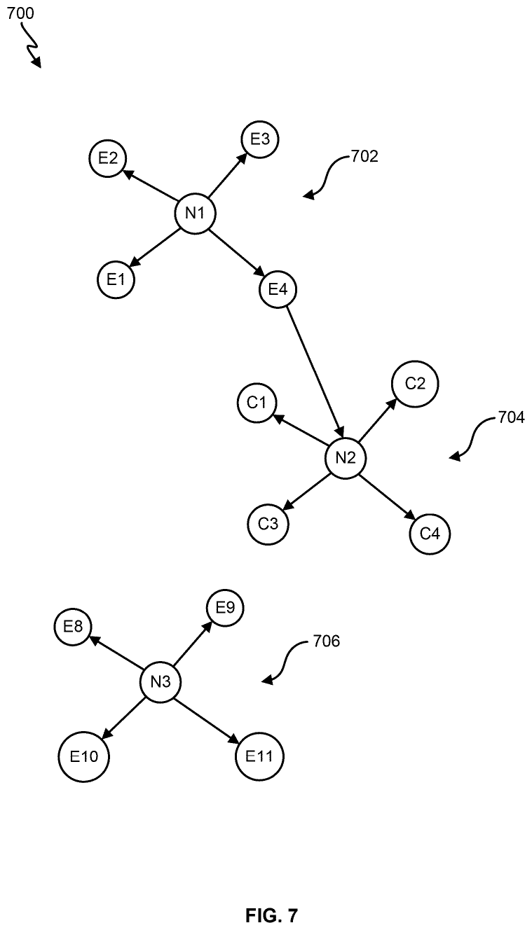

Referring to FIG. 7, illustrates an exemplary illustration depicting a set of clusters 700 of the clustering engine 506 of the AI engagement agent 108 according to an embodiment of the present disclosure. The set of clusters 700 includes clusters 702, 704, and 706. The clusters 702 and 704 are connected through nodes N2 and E4. Every single cluster 702, 704, and 706 includes nodes N1, N2, and N3 respectively representing locations for the events. The nodes E1, E2, E3, and E4 indicate events associated with the node N1. The edges that connect nodes E1, E2, E3, and E4 indicate user preferences such as within 1 km distance from user location, concert, premium seats, and venue availability on weekends. Similarly, C1, C2, C3, and C4 are different sub-clusters. These indicate clusters of events and venues based on user-specific preferences like lunch scheduled today with a close friend, Italian food, somber live music, and metro parking. The edges connecting the node N2 with the clusters C1, C2, C3, and C4 indicate venue availability and time slots and the proximity to the user location. The node N3 is connected with events E8, E9, E10, and E11. These events may indicate rock music concerts with food and shopping outlets. The edges connecting the node N3 with the event nodes E8, E9, E10, and E11 in the cluster 706 may indicate more specific user preferences such as free time slots of users during the concert, favorite drinks, and food preferences.

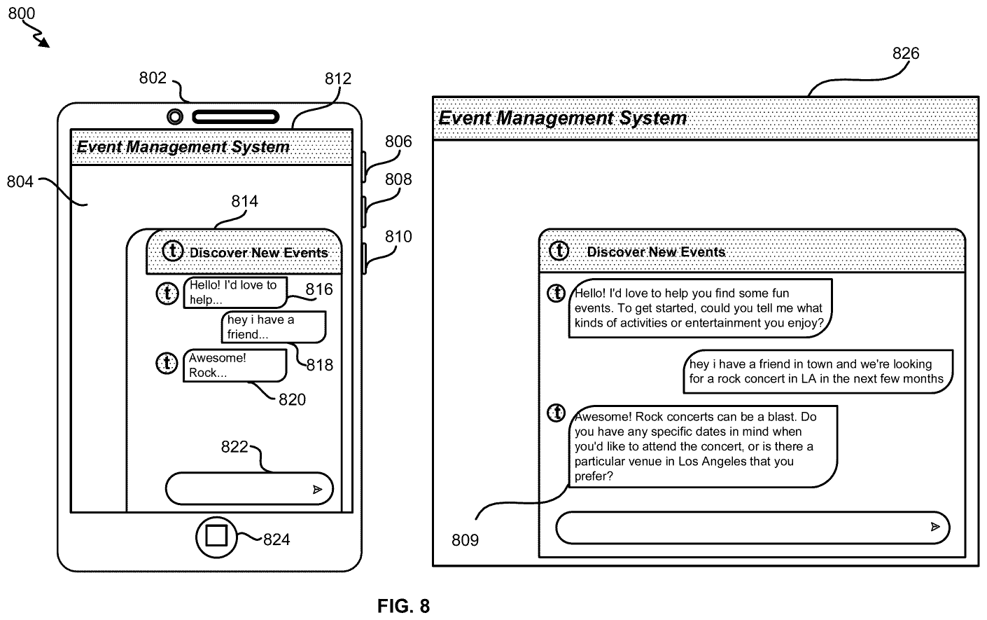

Referring to FIG. 8, illustrates an exemplary embodiment of an event management interface 800 for the event recommendations displayed to the user on the user device(s) in accordance with an embodiment of the present disclosure. A user device 802 includes a user interface 804 that displays multiple soft buttons and options for the interaction with the event management system 100 for event recommendations. A control button 824 is located at the bottom center of the user device 802, which enables the user to access different features of the user device 802. A volume up switch 806 and a volume down switch 808 are used to adjust the volume of the device, and a lock screen button 810 is used to lock screen of user device 802.

An event management application 812 as a mobile application and an event management application 826 as a web application of the event management system 100 running on the user device 802 identifies and catalogues new events based on user-defined search criteria. The event management application 812 includes multiple event management interfaces. This event management system 100 employs machine learning and AI algorithms to search various data sources for user information and update the data cache(s) 110 with the user information. An event interaction module 814 acts as a primary point of interaction between the user and the event management system 100 using the event management application 812. The event management application 812 is designed to be user-friendly and intuitive, allowing users to easily navigate through the application. It includes multiple sections for entering user queries at tab 822, display event recommendations at section 820 and 809, and provide options for user interactions at section 818.

An AI chat-based prototype of the event interaction module 814 interacts with the user device 802 via a two-way interaction. In an exemplary embodiment, the two-way interaction is indicated by sections 816, 818, 820. The interaction ensures a seamless user experience. At section 818, the user inputs the queries using tab 822. In response to the query at section 818, the event management application 812 displays questions to refine the event recommendations at sections 820, and 809 or display the event recommendations based on the user input at section 820. Based on the additional information acquired from the questions, the recommendations in section 820, 809 are refined according to the user queries entered in section 818 and responses to the questions. The event management system 100 analyses the data stored in the data cache(s) 110, including user preferences and past interactions, to generate event recommendations at sections 820 and 809. The AI engagement agent 108 utilizes advanced machine learning algorithms to regularly refine and improve accuracy of its recommendations at sections 820, and 809, ensuring users receive the top relevant event options.

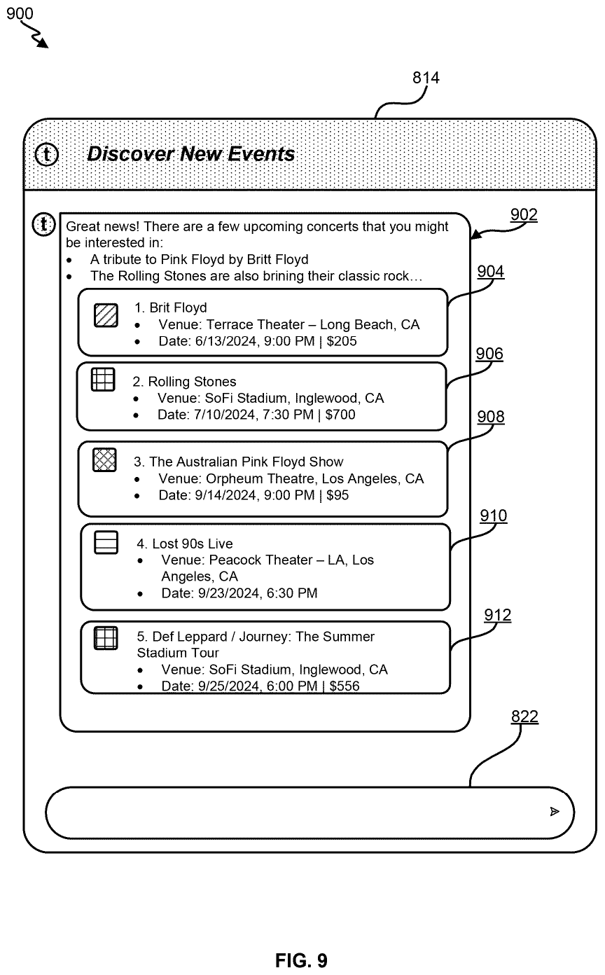

Referring to FIG. 9, illustrates an exemplary embodiment of the event management application 812 designed to provide event recommendations to users in accordance with the present disclosure. In one exemplary embodiment, FIG. 9 depicts a representation of the event management interface 900, which delivers event recommendations to the user through the event interaction module 814 on the user device 802, based on the user information available with the event management system 100. The user interface 804 comprises various soft and hard buttons, as described in FIG. 8, with the event interaction module 814 specifically designated for displaying event recommendations 902 to the user.

The display of the event recommendations 902 are presented in sections 904, 906, 908, 910, and 912, every single representing events that align closely with the user preferences. The users can interact with single event recommendations and select the event that includes user preferences. Additionally, the users can input additional queries in tab 822 to refine the event recommendations 902, allowing the event management system 100 to provide more accurate and tailored suggestions. The event management system 100 regularly updates these recommendations in real-time based on the user input, ensuring that the top relevant and updated information is presented to the user. This process occurs iteratively to enhance the precision of the event recommendations.

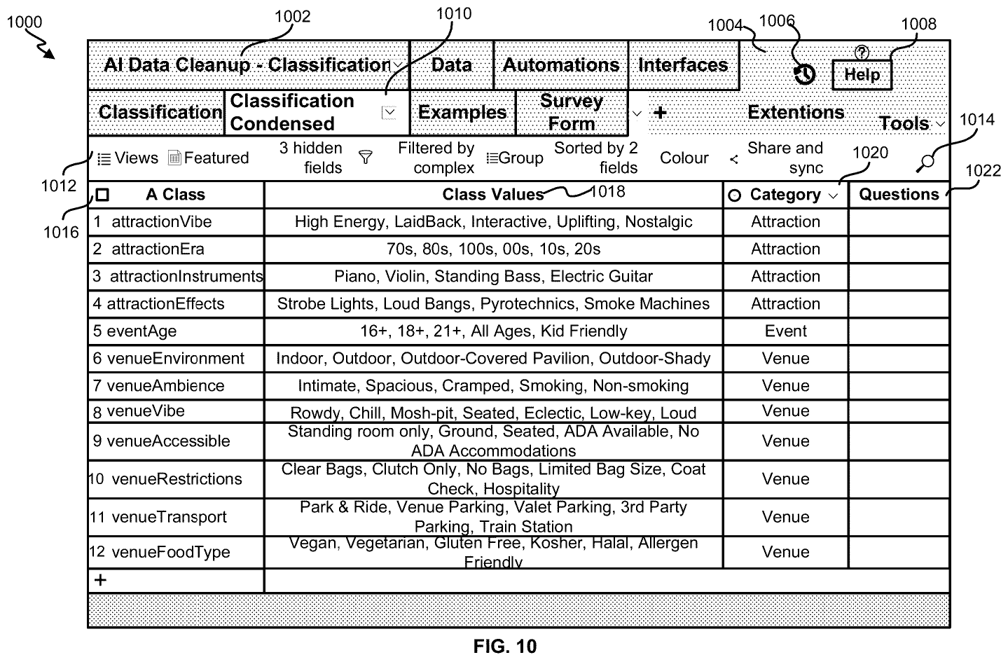

Referring to FIG. 10, illustrates an exemplary embodiment of an automated classification process 1000 and an AI data cleanup classification 1002 of the event management interface of the AI engagement agent 108 of the event management system 100 in accordance with an embodiment of the present disclosure. FIG. 10 represents automating the classification and cleanup 1004 of the data, which is critical for ensuring the accuracy and reliability of the event-related data used in the event management system 100. In section 1006, the history of the event management system 100 is stored, and section 1008 indicates the help section.

The automated classification process 1000 displays the data for a classification condensed section 1010. Section 1012 includes multiple filtrations of the data presented to the user based on multiple factors. Multiple factors include the venue, event, and user. Section 1014 of the automated classification process 1000 is used to search for data. Classification classes 1016, class values 1018, category values 1020, and queries 1022 indicate the data classification.

The classification classes 1016 are crucial for organizing events and venue data. The classification classes 1016 include Attraction Vibe, Attraction Era, Attraction Instruments, Attraction Effects, Event Age, Venue Environment, Venue Ambience, and Venue Accessibility. Every single one of classification classes 1016 is designed to capture specific attributes of the event or venue, making it easier to classify and retrieve relevant data. For example, the Attraction Vibe classification class includes class values 1018, such as “High Energy,” “Laid-back,” “Interactive,” “Uplifting,” and “Nostalgic.” The classification classes 1016 values help identify an event's atmosphere, allowing users to find events that match their anticipated experience or preferences. Similarly, Attraction Era classification classes 1016 spans different decades, from the '70s to the '20s, providing a temporal context to events, particularly useful for users seeking nostalgia or era-specific experiences.

The Attraction Instruments and Attraction Effects row of classification classes 1016 focus on the technical and sensory aspects of events. Attraction Instruments included in the class values 1018 options like “Piano,” “Violin,” “Standing Bass,” and “Electric Guitar,” which are crucial for users who have specific user preferences for musical elements. Meanwhile, Attraction Effects such as “Strobe Lights,” “Loud Bangs,” “Pyrotechnics,” and “Smoke Machines” cater to user preferences in the visual and auditory impact of an event. The Event Age row of classification classes 1016 ensures that events are categorized based on age appropriateness, with class values 1018 like “16+,” “18+,” “21+,” “All Ages,” and “Kid Friendly.” This is particularly crucial for users who want to filter the events based on age restrictions or family-friendliness.

The classification classes 1016 are related to “Venue Environment” and “Venue Ambience” and are used to describe the physical and atmospheric characteristics of events or venues. The class values 1018 for “Venue Environment” options, such as “Indoor,” “Outdoor,” “Outdoor-Covered Pavilion,” and “Outdoor-Shady”, help users select venues based on a user-preferred setting. Venue Ambiences like “Intimate,” “Spacious,” “Cramped,” “Smoking,” and “Non-smoking” provide additional context to help users choose venues that match their comfort level and expectations or preferences. The Venue Accessibility row of classification classes 1016 is crucial for ensuring inclusivity. The class values 1018 includes options like “Standing room only,” “Ground,” “Seated,” “ADA Available,” and “No ADA Accommodations.” This classification classes 1016 helps users with specific accessibility demands to find venues that cater to user prerequisites.

Additional classification row of the classification classes 1016 cover practical aspects such as Venue Restrictions (e.g., “Clear Bags,” “Clutch Only,” “No Bags,” “Limited Bag Size,” “Coat Check,” “Hospitality”), Venue Transport (e.g., “Park & Ride,” “Venue Parking,” “Valet Parking,” “3rd Party Parking,” “Train Station”), and Venue Food Type (e.g., “Vegan,” “Vegetarian,” “Gluten Free,” “Kosher,” “Halal,” “Allergen Friendly”). The classification classes 1016 ensure that users can find the events and the venues that meet user logistical and dietary user preferences. The automated classification process 1000 described in FIG. 10 is designed to be highly efficient, with the ability to sort, filter, sync, and share the data based on multiple fields. This ensures that the data is accurate and relevant and easily accessible to the users, enabling them to make informed decisions about the events.

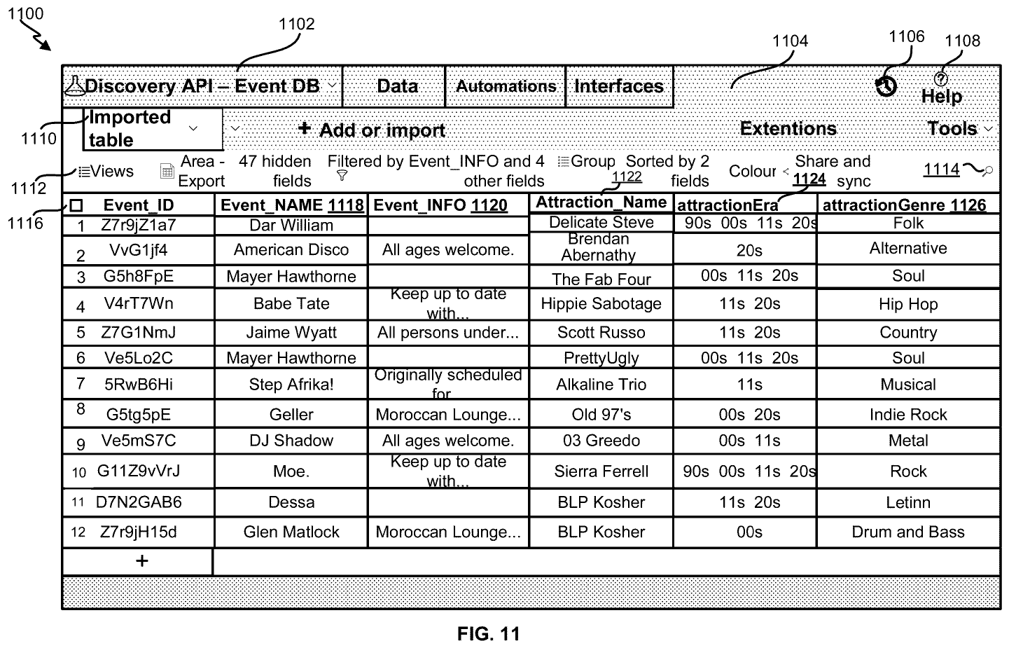

Referring to FIG. 11, illustrates an exemplary embodiment of an event management interface 1100 designed to manage and automate event data classification in accordance with the present disclosure. The event management interface 1100 represents an event database 1102 with a structured approach to automate the classification 1104 of the data. The event database 1102 is organized into multiple sections that facilitate an import table 1110, classifications of the events data in different sections, filtering, and organization of the events data for improving the event recommendations based on the Event database 1102. Section 1106 history is stored for the event management system 100 and sector 1108 indicates the help section.

The import table 1110 displays event related data in a tabular format. A section 1112 includes multiple filtrations of the data based on multiple factors. The multiple factors include venue, event, and user. A section 1114 includes a searchable option for data. The import table 1110 contains sections like Event ID 1116, Event Name 1118, Event Info 1120, Attraction Name 1122, Attraction Era 1124, and Attraction Genre 1126. Every single section in the import table 1110 represents a distinct event, with relevant details captured under classification of the events data. For example, Event ID 1116 provides a standout identifier for every single one of the events, while Event Name 1118 and Attraction Name 1122 list the primary performer or attraction. The Event Info 1120 includes details, such as age restrictions or crucial notes, and Attraction Era 1124 and Attraction Genre 1126 classify the events based on time period and musical style, respectively.

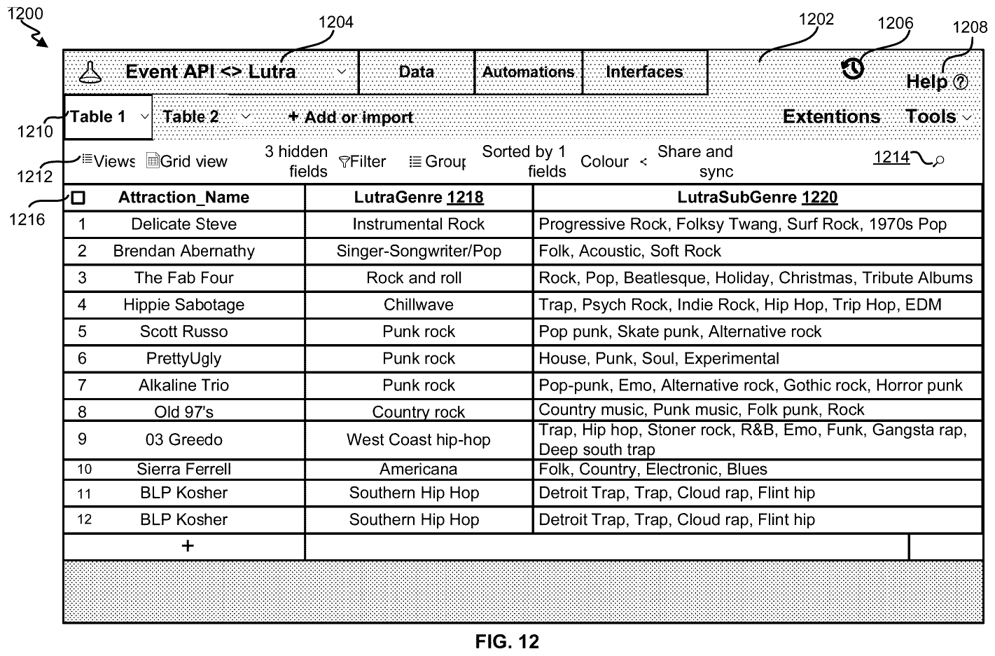

Referring to FIG. 12, illustrates an exemplary embodiment of an event management interface 1200 designed to manage and classify event-related information in accordance with the present disclosure. The event management interface 1200 provides an Event database 1202 to automate the classification 1204 of event-related information. The Event database 1202 is organized into multiple sections, facilitating the use of a Table View Selector 1210, which allows for the efficient filtering, sorting, and organization of event data. This organization improves the accuracy of event recommendations generated by the event management system 100, which leverages the structured data within the Event database 1202 and presents it in a grid view. The event management interface 1200 includes section 1206, which stores the history related to the event management system 100, and section 1208, which indicates the help section, providing support and guidance within the event management system 100.

The Table View Selector 1210 allows to switch between different table views, such as “Table 1” and “Table 2,” or to import new data into the system via an Add or Import button. This feature enables flexible management of multiple datasets within the application, catering to various user demands. Table 1 displays event-related data in a tabular format in one exemplary embodiment. Section 1212 provides options for filtering data based on multiple factors related to Genre and Subgenre. Section 1214 includes a searchable option for refining the data. Table 1 contains columns such as Attraction Name 1216, Genre Type 1218, and Subgenre Type 1220. Every single row within Table 1 corresponds to a specific event, artist, or attraction, with detailed classifications provided in the Genre Type 1218 and Subgenre Type 1220 columns. For example, “Delicate Steve” is classified under “Instrumental Rock” with subgenres including “Progressive Rock, Folksy Twang, Surf Rock, and 1970s Pop,” offering a detailed categorization that aids in precise event recommendations.

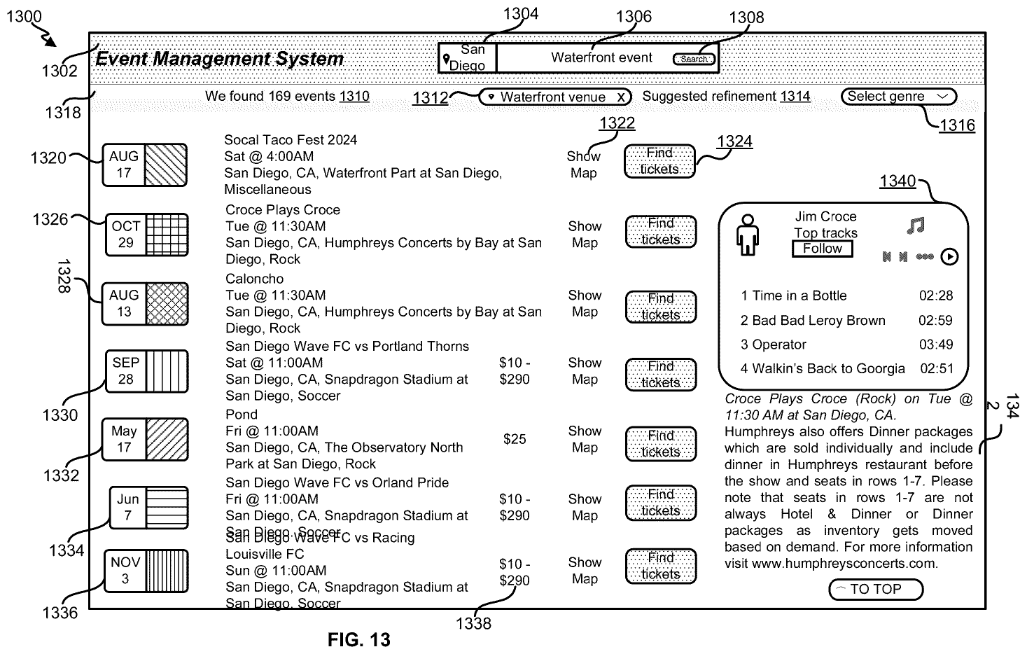

Referring to FIG. 13, illustrates an exemplary embodiment of the event management application 712, designed to provide event recommendations to users in accordance with the present disclosure. In one embodiment, FIG. 13 depicts the event management interface 1300, which delivers event recommendations to the user through the Event Interaction Module 1302, based on a user input. The user input is divided into various sections, including Location 1304, User Preference Input 1306, and a searchable option at section 1308.

The event management interface 1300 presents recommendations based on the user input. When a user interacts with section 1308, the event management interface 1300 generates recommendations. Section 1310 displays the number of results found based on the user input, while section 1312 represents the user preferences at a particular location. Section 1314 includes an advanced feature for refining the event recommendations more precisely, using section 1316, where users can select additional preferences like genres. The recommendations are updated in real-time based on selections made in section 1316, ensuring alignment with the user preferences.

The event management interface 1300 represents the event recommendations in section 1318. Section 1318 includes multiple subsections 1320, 1326, 1328, 1330, 1332, 1334, and 1336 every single of them providing specific details about the event recommended. These details include the date of the event, event image, event name, event time, exact location, and the genre or subgenre of the event. Additionally, section 1318 includes subsections 1322, 1324, and 1338. Subsection 1322 represents the location on a map to provide directions to the user, subsection 1324 offers options for finding tickets and booking, and subsection 1338 displays the prices of the event or ticket prices.

In the event management interface 1300, section 1318 also includes subsections 1340 and 1342. Subsection 1340 allows the user to view a visual representation of any event they are interested in or want to view, and subsection 1342 provides more detailed information about the event.

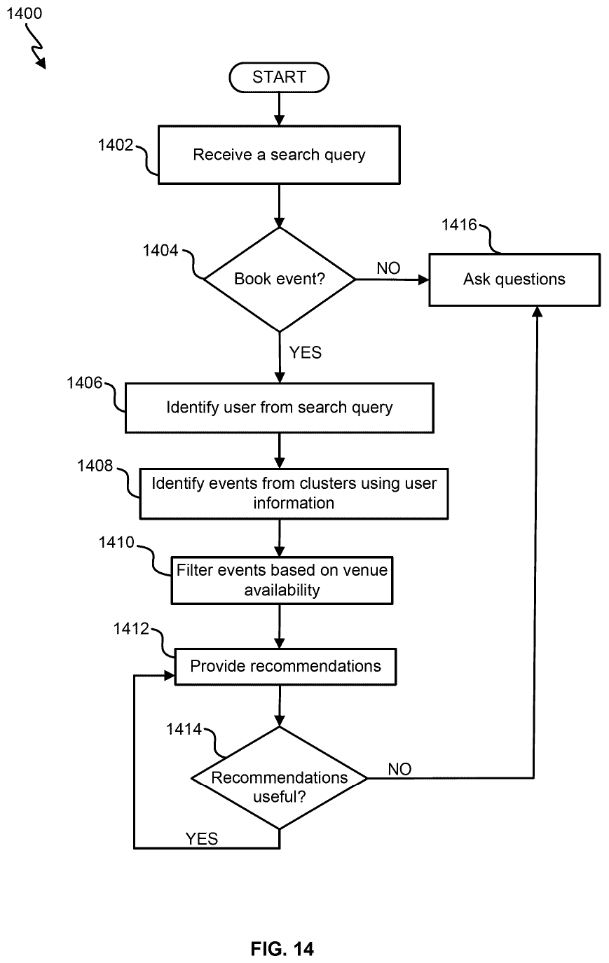

Referring to FIG. 14, illustrates a flowchart describing a process 1400 for recommending a set of events based on user preferences using Artificial Intelligence (AI) techniques according to another embodiment of the present disclosure. The process 1400 begins when a user searches for events by entering a search query on a mobile or web application of the event management system 100. At block 1402, the AI engagement agent 108 receives the search query to identify keywords from the search query. At block 1404, it is determined by the AI engagement agent 108 whether the user is booking an event or searching for event-related information based on the keywords.

At block 1406, when it is determined that the user is booking the event and adequate information is available from the search query, then the user is identified from the search query. Else, at block 1416, the user is questioned again to acquire more details from the user. User profile is retrieved from data cache(s) 110 based on the identified user. The user profile includes user information, user real-time schedules, past event bookings, browsing history, and user preferences associated with the events or venues.

At block 1408, one or more clusters of events are identified from the clustering engine 506 of the AI engagement agent 108 based on the user profile and the keywords. The clusters include nodes that indicate events based on user location or preference and edges indicate specific user preferences like parking, ambiance, lighting, food, etc.

At block 1410, the events from the clusters are filtered to obtain a set of events based on user location, venue availability, and user schedules. Based on the set of events, a list of recommended events is generated based on the user-specific prerequisites and user preferences obtained from additional questions at block 1416. The recommendations are refined, scored, and ranked based on the information extracted from the additional questions.

At block 1412, the list of recommendations is presented to the user on the end-user device(s) 104 in response to the search query. The list of recommendations includes events matching the user-specific prerequisites and preferences.

At block 1414, the user provides feedback on the recommended events presented to the user. The feedback may be provided in terms of ratings or additional information. If the user is satisfied with the recommended events, then at block 1412, the same recommendations are displayed on the user interface of the end-user device(s) 104. Otherwise, at block 1416, the user will be asked further questions to gather additional information. Based on the additional information from the user, the list of recommended events is updated and presented to the user.

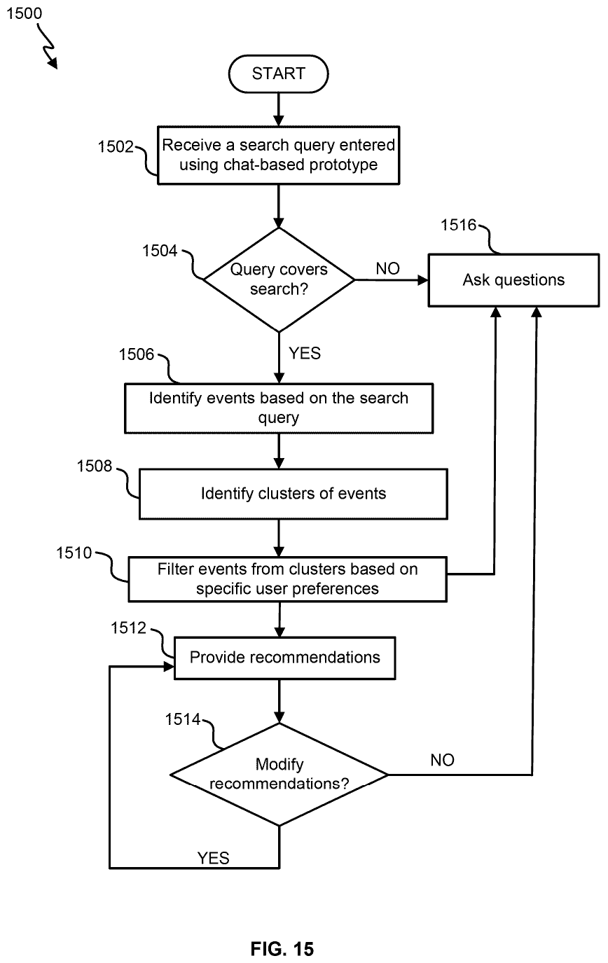

Referring to FIG. 15, illustrates a flowchart of a process 1500 for recommending a set of events based on user search entered using a chat-based prototype and an artificial intelligence (AI) engagement agent according to another embodiment of the present disclosure. The process begins at block 1502, where a user searches for event recommendations by entering a search query on the mobile application or website application of the event management system 100. The search query is entered using a chat-based prototype. The chat-based prototype may be based on artificial intelligence.

Block 1504 determines whether the user is searching specific events for booking or performing a broad search based on the search query. If the user is booking for an event, then at block 1516, further questions are asked to the user through the chat-based prototype to extract more details from the user. If the user randomly searches for the events, then at block 1506, events are identified by the AI engagement agent 108 based on the search query.

At block 1508, AI engagement agent 108 identifies clusters of events based on the search query. The cluster of events includes events aggregated in the cluster based on common attributes of user preferences, for example, user location, venue location of the events, parking, food preferences, etc. The user preferences are obtained from the data cache(s) 110.

At block 1510, one or more events from the clusters are filtered based on the specific user preferences received from questioning the user at block 1516. The specific user preferences may include answers to questions regarding user's prerequisites, like parking slots, metro connectivity, cab availability, seating arrangements, lighting, decor, food, noise, or music.

At block 1512, recommendations are generated by the AI engagement agent 108 based on the filtered events from the clusters of events. The recommendations are provided to the user on the end-user device(s) 104 of the user as a list of events.

At block 1514, the user is requested to provide either feedback or answer questions regarding whether the list of events satisfies the prerequisites. If the user is satisfied with the recommendations, then at block 1512, the recommendations are presented to the user. At block 1516, the user is asked further questions to modify the recommendations with events. The modification is based on the answers the user provides to the questions. More detailed information is retrieved from the answers to filter events from the clusters.

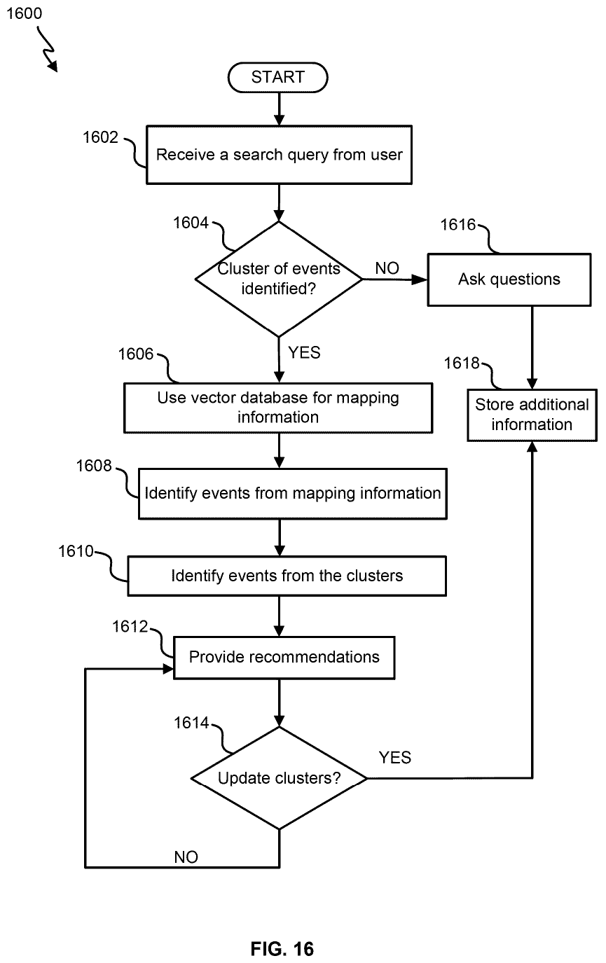

Referring to FIG. 16, illustrates a flowchart of a process 1600 for recommending a set of events based on clusters of events using the AI engagement agent 108 according to another embodiment of the present disclosure. The process begins at block 1602, where the user searches for events on a ticketing application or a mobile application installed on the end-user device(s) 104. The search is performed using a keystring.

At block 1604, the AI engagement agent 108 identifies keywords from the keystring. The keystring may be in natural language. The AI engagement agent 108 identifies the search strategy from the keystring using natural language processing techniques. A set of clusters of events are identified based on the keystring. If the keystring is broad or more information is entailed for identifying specific events for the user, then at block 1616, more questions are asked from the user using a chat-based prototype.

At block 1606, the clusters include a mapping of events, venues, categories and subcategories associated with a number of events, and the mapping is stored in a vector database (part of the data cache(s) 110). The data cache(s) 110 also includes user related information including past booking information, user preferences, views, purchases and browsing history.

At block 1608, mapping information is obtained from the mapping of the events, venues, categories, and subcategories. For example, an event X has a category of musical event, sub-category as rock concert, and the venue is located in proximity (within 5 kms) to the user's location.

At block 1610, the events are identified from the clusters using the mapping information. The user-related information is further used to filter the events from the clusters.

At block 1612, the AI engagement agent 108 is used to identify recommendations based on the events identified from the clusters at block 1610. The recommendations are based on the ranking order of the events. The ranking order is set based on specific user preferences, such as schedules, parking, lighting, music, ambiance, food, etc.

At block 1614, the events in the clusters are updated or new clusters are generated based on the determination of updated information related to new events, venues, or updated user preferences and schedules. Updated information is obtained in real-time based on tracking the user's location, events, and venues. The updates on user preferences are acquired at block 1616 by asking more questions from the user. Additional information on the user preferences is obtained based on answers to the questions.

At block 1618, the additional information is stored in the vector database of the data cache(s) 110 for further processing and retrieval.

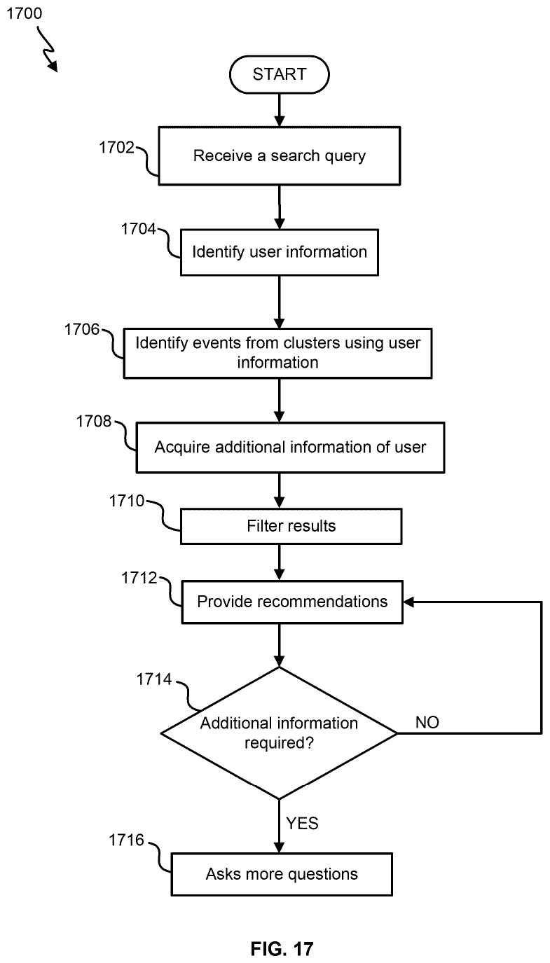

Referring to FIG. 17, illustrates a flowchart of a process 1700 for recommending a set of events based on additional user information using an Artificial Intelligence (AI) engagement agent according to another embodiment of the present disclosure. The process begins at block 1702, where the user enters a search query for events using the event management system 100 mobile application installed on the end-user device(s) 104. The user may use an interactive AI chat-based prototype to enter the search query. The AI engagement agent 108 receives the search query from the user for analysis.

At block 1704, the AI engagement agent 108 identifies the user from the search query and obtains user information from the data cache(s) 110. The data cache(s) 110 stores user information of users who queried for events, booked events, or browsed the events using the mobile application. If the user is a first-time user, then the AI engagement agent 108 uses various social media platforms and/or presents questionnaires to the user on the mobile application to acquire user information.

At block 1706, clusters including events are identified based on the search query and the user information obtained from the data cache(s) 110 and the user. The clusters include a mapping of events, venues, categories and subcategories associated with events, and the mapping is stored in a vector database of the data cache(s) 110.

At block 1708, additional information associated with the user is obtained such as user preferences for food, parking, music, seating etc. in the events. The additional information is obtained by asking questions from the user. In some examples, the additional information includes user activities and schedules.

At block 1710, the cluster of events identified based on the user information are filtered and updated based on the additional information of the user. The clusters or the events in the clusters may change based on additional information.

At block 1712, recommendations of the events are provided to the user on the end-user device(s) 104 based on the events identified from the clusters at block 1710. The recommendations may be in the form of a list of events presented to the user in the order of priority for the user. The priority may be set based on the user preferences. User feedback is received regarding the recommendations.

At block 1714, the AI engagement agent 108 determines whether additional user information is required based on the user feedback. If the user is not satisfied with the list of events presented to the user, at block 1716, more questions are asked of the user to get additional user information otherwise, if the user is satisfied with the list of events, then the recommendations are presented to the user. Based on additional user information, the list of events is updated and presented to the user on the user interface of the end-user device(s) 104.

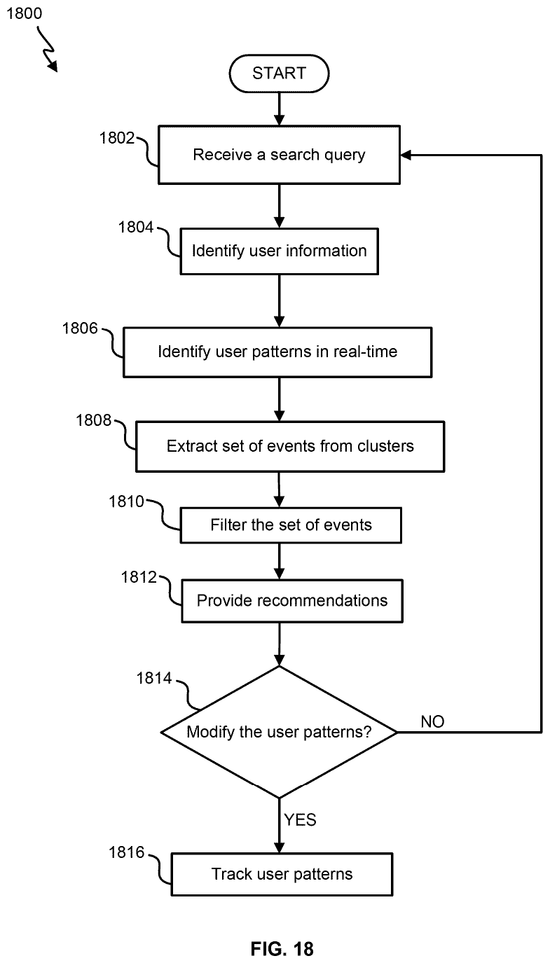

Referring to FIG. 18, illustrates a flowchart of process 1800 for recommending a set of events based on user patterns using the AI engagement agent 108 according to another embodiment of the present disclosure. The process 1800 begins at block 1802, where the user enters a search query for events using the event management system 100 mobile application installed on the end-user device(s) 104. The user may use an AI chat-based prototype to enter the search query. The AI engagement agent 108 receives the search query from the user. The AI engagement agent 108 may interpret the search query using natural language processing.

At block 1804, user information is obtained from the data cache(s) 110 or directly from the user. The user information includes user preferences, user details, and user location.

At block 1806, user patterns are identified from the user information. The user patterns include user activities, location, preferences, and real-time user schedules.

At block 1808, clusters of events are identified based on user patterns, user information, and search queries. The clusters of events include a mapping of events, venues, categories, and subcategories associated with the events, and the mapping is stored in a vector database. The vector database is a part of the data cache(s) 110. User-specific preferences such as parking, food, music, ambiance, seating, etc., are acquired from the data cache(s) 110 and/or the user.

At block 1810, a set of events is obtained by filtering the events from the clusters of events based on the user preferences. The set of events includes events that satisfy user preferences.

At block 1812, recommendations are generated based on the set of events. The recommendations include the events ranked in the order of user preferences and presented to the user on the user interface of the end-user device(s) 104. The recommendations include details of the events along with the events.

At block 1814, determination is made whether to modify the user patterns based on updated user information. The user information is updated in real-time. For example, changing the user schedule (user availability) for a weekend event may change the event recommendations. If the user information is not updated, then the recommendations are presented to the user, or a new search query is received from the user.

At block 1816, the user patterns are modified based on real-time user information tracking, such as user's location, schedule, health, or other preferences. The recommendations are changed based on the modified user patterns. The changed recommendations are presented to the user on end-user device(s) 104.

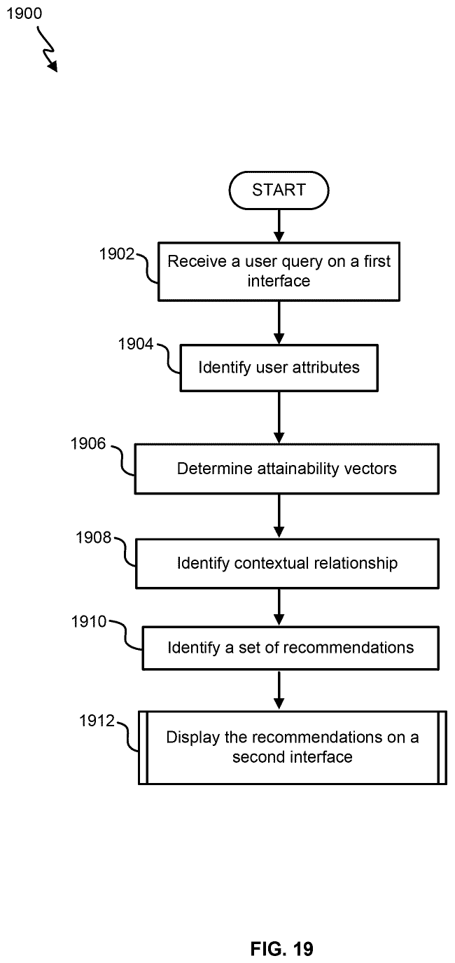

Referring to FIG. 19, illustrates a flowchart of a process 1900 for providing a set of recommendations associated with an event based on contextual relationship between user attributes and attainability vectors according to another embodiment of the present disclosure. The process begins at block 1902, where the user query is received from a user using the first interface 608 of the system application running on the end-user device(s) 104. The user query may be a natural language-based query.

At block 1904, user attributes are identified by processing the user query. The user attributes include user specific prerequisites and use information. The user may be already registered with the system application or may be a first-time user. User profiles are stored in the data cache(s) 110 if the user is already registered. If the user is new, registration is performed, and the user profile is stored in the data cache(s) 110.

At block 1906, attainability vectors are determined from the vector database based on the user attributes. The attainability vectors are determined based on the user attributes using a plurality of vectors from the vector database of the data cache(s) 110. The plurality of vectors indicates availability of user attributes for every single user registered in the vector database. The attainability vectors indicate the availability of the user specific prerequisites by checking the prerequisites against an event management server (not shown). The vector database is synchronized with the recent update from the event management server.

The attainability vectors include availability of the user specific prerequisites or user specific requirements of the user interacting on the first interface 608. The attainability vectors form clusters of events or venues based on meeting the user specific prerequisites. Machine learning models process the real-time and historical logs of the user to determine the user specific preferences. The user specific preferences are checked for availability in the vector database to generate attainability vectors for one or more events. Clusters are generated for the events based on the attainability vectors.

At block 1908, contextual relationship is identified between the user attributes and the attainability vectors. The contextual relationship indicates a matching of the user specific prerequisites with the availability of the user specific prerequisites for one or more events.

At block 1910, the set of recommendations based on the contextual relationship between the user attributes and the plurality of attainability vectors is identified. The set of recommendations includes a list of events displayed in order to meet the user specific prerequisites.

At block 1912, the set of recommendations are displayed on the second interface 610. The second interface 610 simultaneously displays the recommended events, venues, seating, parking, and other user preferences based on the user interactions on the first interface 608.

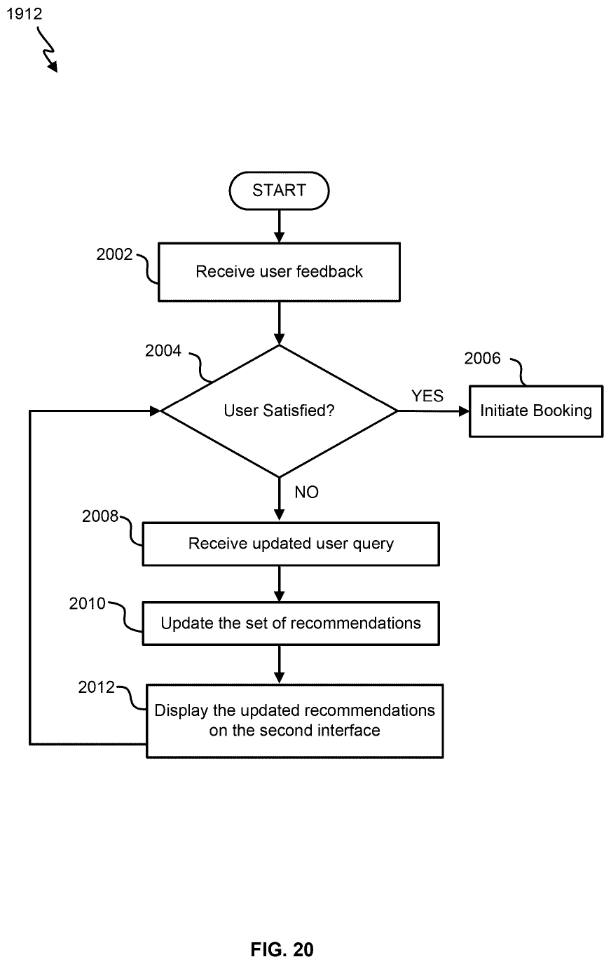

Referring to FIG. 20, illustrates a flowchart of a process performed at the block 1912 for providing the set of recommendations based on user feedback on previous recommendations according to another embodiment of the present disclosure. The process begins at block 2002, where user feedback is received using the first interface 608 on the set of recommendations displayed to the user on the second interface 610. The user feedback may be provided using the speech recognition or textual input on the first interface 608.

At block 2004, it is determined whether the user is satisfied with the set of recommendations based on the user feedback. If the user is satisfied with the set of recommendations, the user is requested to select one or more recommended events and initiate booking with the selected one or more recommended events at block 2006.

At block 2008, if the user is not satisfied with the set of recommendations displayed to the user, the user is requested to provide specific inputs to update the user query. The user query is changed by the user and updated user query is received on the first interface 608.

At block 2010, the set of recommendations are updated based on the updated user query provided by the user on the first interface 608. The set of recommendations is changed based on the user input obtained from the user feedback.

At block 2012, the updated set of recommendations are provided to the user on the second interface 610. The user is again requested for the feedback, and the process moves to block 2004. The set of recommendations is updated till the user is satisfied with the recommendations or wants to end the search for events.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, non-volatile, or other storage medium and is not to be limited to any particular type of memory or number of memories, or type of media upon which memory is stored.

In the embodiments described above, for the purposes of illustration, processes may have been described in a particular order. It should be appreciated that in alternate embodiments, the methods may be performed in a different order than that described. It should also be appreciated that the methods and/or system components described above may be performed by hardware and/or software components (including integrated circuits, processing units, and the like), or may be embodied in sequences of machine-readable, or computer-readable, instructions, which may be used to cause a machine, such as a general-purpose or special-purpose processor or logic circuits programmed with the instructions to perform the methods. Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, and/or various other storage mediums capable of storing that contain or carry instruction(s) and/or data. These machine-readable instructions may be stored on one or more machine-readable mediums, such as CD-ROMs or other type of optical disks, solid-state drives, tape cartridges, ROMs, RAMs, EPROMs, EEPROMs, magnetic or optical cards, flash memory, or other types of machine-readable mediums suitable for storing electronic instructions. Alternatively, the methods may be performed by a combination of hardware and software.

Implementation of the techniques, blocks, steps, and means described above may be done in various ways. For example, these techniques, blocks, steps, and means may be implemented in hardware, software, or a combination thereof. For a digital hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. For analog circuits, they can be implemented with discreet components or using monolithic microwave integrated circuit (MMIC), radio frequency integrated circuit (RFIC), and/or micro electro-mechanical systems (MEMS) technologies.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

The methods, systems, devices, graphs, and tables discussed herein are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims. Additionally, the techniques discussed herein may provide differing results with different types of context awareness classifiers.

Unless defined otherwise, all technical and scientific terms used herein have the same meaning as commonly or conventionally understood. As used herein, the articles “a” and “an” refer to one or to more than one (i.e., to at least one) of the grammatical object of the article. By way of example, “an element” means one element or more than one element. “About” and/or “approximately” as used herein when referring to a measurable value such as an amount, a temporal duration, and the like, encompasses variations of ±20% or ±10%, ±5%, or +0.1% from the specified value, as such variations are appropriate to in the context of the systems, devices, circuits, methods, and other implementations described herein. “Substantially” as used herein when referring to a measurable value such as an amount, a temporal duration, a physical attribute (such as frequency), and the like, also encompasses variations of ±20% or ±10%, ±5%, or +0.1% from the specified value, as such variations are appropriate to in the context of the systems, devices, circuits, methods, and other implementations described herein.

As used herein, including in the claims, “and” as used in a list of items prefaced by “at least one of” or “one or more of” indicates that any combination of the listed items may be used. For example, a list of “at least one of A, B, and C” includes any of the combinations A or B or C or AB or AC or BC and/or ABC (i.e., A and B and C). Furthermore, to the extent more than one occurrence or use of the items A, B, or C is possible, multiple uses of A, B, and/or C may form part of the contemplated combinations. For example, a list of “at least one of A, B, and C” may also include AA, AAB, AAA, BB, etc.

While illustrative and presently preferred embodiments of the disclosed systems, methods, and machine-readable media have been described in detail herein, it is to be understood that the inventive concepts may be otherwise variously embodied and employed, and that the appended claims are intended to be construed to include such variations, except as limited by the prior art.

While the principles of the disclosure have been described above in connection with specific apparatuses and methods, it is to be clearly understood that this description is made only by way of example and not as limitation on the scope of the disclosure.

We claim:

1. A method of providing a set of recommendations associated with an event of a plurality of events based on contextual relationship between user attributes and a plurality of attainability vectors using an Artificial Intelligence (AI) engagement agent, the method comprising:
receiving a natural language-based user query for the set of recommendations on a first interface;
identifying the user attributes from the natural language-based user query;
determining the plurality of attainability vectors from a vector database based on the user attributes;
identifying the contextual relationship between the user attributes and the plurality of attainability vectors;
identifying, using the AI engagement agent, the set of recommendations based on the contextual relationship between the user attributes and the plurality of attainability vectors; and
displaying the set of recommendations on a second interface, wherein the first interface and the second interface are displayed using a system application run on an end-user device.

2. The method of claim 1, further comprising:
determining a plurality of venues for a set of events;
filtering the set of events based on venue availability to get a filtered set of events; and
providing a set of recommended events on the end-user device based on the filtered set of events.

3. The method of claim 1, wherein the user attributes are associated with user prerequisites, wherein the user prerequisites include parking preferences, lighting, ambience, very important person (VIP) seating, food, music, indoor or outdoor venues, and real-time updates from a user.

4. The method of claim 1, wherein the first interface includes a chat-based prototype that uses the AI engagement agent to:
process a user query;
filter a set of events from a plurality of clusters based on user information from the user attributes, wherein the plurality of clusters includes a mapping of venues, categories and subcategories associated with the plurality of events, and the mapping is stored in the vector database;
provide a set of recommended events on the end-user device based on the set of events;
request a user input to change the user query;
receive the user input on the first interface to update the set of recommended events based on a change in the user query; and
dynamically present in real-time, an updated set of recommended events on the second interface.

5. The method of claim 4, wherein:
the categories include genre,
the subcategories include sub-genres in music,
the plurality of clusters includes nodes connected with edges, and
the nodes indicate venue locations, and the edges indicate user preferences.

6. The method of claim 1, further comprising:
obtaining additional information related to a user, wherein the additional information includes user preferences, user activities, and schedules;
filtering the set of events based on the additional information to generate a filtered set of events; and
providing a set of recommended events to the user on the second interface based on the filtered set of events.

7. The method of claim 1, further comprising:
obtaining user patterns from user information, wherein the user patterns include user activities, user location, user preferences, and real-time user schedules;
obtaining, using the AI engagement agent, the set of events from a plurality of clusters based on the user preferences, wherein the plurality of clusters includes a mapping of events, venues, categories and subcategories associated with the plurality of events, and the mapping is stored in the vector database;
generating a set of recommendations based on the set of events; and
providing a set of recommended events on the second interface based on the set of events.

8. An event management system for providing a set of recommendations associated with an event of a plurality of events based on contextual relationship between user attributes and a plurality of attainability vectors using an artificial intelligence (AI) engagement agent, the event management system comprising:
a system application running on an end-user device, the system application includes a first interface and a second interface; and
an AI engagement agent configured to process a user query to provide search results, the AI engagement agent is further configured to:
receive a natural language-based user query for the set of recommendations on the first interface;
identify the user attributes from the natural language-based user query;
determine the plurality of attainability vectors from a vector database based on the user attributes;
identify the contextual relationship between the user attributes and the plurality of attainability vectors;
identify the set of recommendations based on the contextual relationship between the user attributes and the plurality of attainability vectors;
display the set of recommendations on the second interface.

9. The event management system of claim 8, wherein the AI engagement agent is further configured to:
determine a plurality of venues for a set of events;
filter the set of events based on venue availability to get a filtered set of events; and
provide a set of recommended events on the end-user device based on the filtered set of events.

10. The event management system of claim 8, wherein the user attributes are associated with user prerequisites, wherein the user prerequisites include parking preferences, lighting, ambience, very important person (VIP) seating access, food, music, indoor or outdoor seating, and real-time updates from a user.

11. The event management system of claim 8, wherein the AI engagement agent determines the plurality of attainability vectors based on the user attributes using a plurality of vectors from the vector database, and the plurality of vectors indicates availability of the user attributes of a plurality of users registered in the vector database.

12. The event management system of claim 8, wherein the first interface includes a chat-based prototype that uses the AI engagement agent to:
process the user query;
filter a set of events from a plurality of clusters based on user information from the user attributes, wherein the plurality of clusters includes a mapping of venues, categories and subcategories associated with the plurality of events, and the mapping is stored in the vector database;
provide a set of recommended events on the end-user device based on the set of events;
request a user input to change the user query;
receive the user input on the first interface to update the set of recommended events based on a change in the user query; and
dynamically present in real-time, an updated set of recommended events on the second interface.

13. The event management system of claim 12, wherein:
the categories include genre,
the subcategories include sub-genres in music,
the plurality of clusters includes nodes connected with edges, and
the nodes indicate venue locations, and the edges indicate user preferences.

14. The event management system of claim 8, wherein the AI engagement agent is further configured to:
obtain additional information related to a user, wherein the additional information includes user preferences, user activities, and schedules;
filter the set of events based on the additional information to generate a filtered set of events; and
provide a set of recommended events to the user on the second interface based on the filtered set of events.

15. The event management system of claim 8, wherein the AI engagement agent is further configured to:
obtain user patterns from user information, wherein the user patterns include user activities, user location, user preferences, and real-time user schedules;
obtain, using the AI engagement agent, the set of events from a plurality of clusters based on the user preferences, wherein the plurality of clusters includes a mapping of events, venues, categories and subcategories associated with the plurality of events, and the mapping is stored in the vector database;
generate a set of recommendations based on the set of events; and
provide a set of recommended events on the second interface based on the set of events.

16. A non-transitory computer-readable medium containing instructions that, when executed by a processor, cause the processor to perform a method for providing a set of recommendations associated with an event of a plurality of events based on contextual relationship between user attributes and a plurality of attainability vectors using an Artificial Intelligence (AI) engagement agent, the method comprising:
receiving a natural language-based user query for the set of recommendations for the plurality of events on a first interface;
identifying the user attributes from the natural language-based user query;
determining the plurality of attainability vectors from a vector database based on the user attributes;
identifying contextual relationship between the user attributes and the plurality of attainability vectors;
identifying, using an AI engagement agent, the set of recommendations based on the contextual relationship between the user attributes and the plurality of attainability vectors;
displaying the set of recommendations on a second interface, wherein the first interface and the second interface are displayed using a system application run on an end-user device.

17. The non-transitory computer-readable medium of claim 16, wherein the method further comprising:
determining a plurality of venues for a set of events;
filtering the set of events based on venue availability to get a filtered set of events; and
providing a set of recommended events on the end-user device based on the filtered set of events.

18. The non-transitory computer-readable medium of claim 16, wherein the user attributes are associated with user prerequisites, and the user prerequisites include parking preferences, lighting, ambience, very important person (VIP) seating access, food, music, indoor or outdoor seating, and real-time updates from a user.

19. The non-transitory computer-readable medium of claim 16, wherein the first interface includes a chat-based prototype that uses the AI engagement agent to:
process a user query;
filter a set of events from a plurality of clusters based on user information from the user attributes, wherein the plurality of clusters includes a mapping of venues, categories and subcategories associated with the plurality of events, and the mapping is stored in the vector database;
provide a set of recommended events on the end-user device based on the set of events;
request a user input to change the user query;
receive the user input on the first interface to update the set of recommended events based on a change in the user query; and
dynamically present in real-time, an updated set of recommended events on the second interface.

20. The non-transitory computer-readable medium of claim 19, wherein:
the categories include genre,
the subcategories include sub-genres in music,
the plurality of clusters includes nodes connected with edges,
the nodes indicate venue locations, and the edges indicate user preferences.
